(19) United States
(12) Patent Application Publication
(10) Pub. No.: US 2026/0056803 A1
(43) Pub. Date: Feb. 26, 2026

(54) RECRUITMENT OF SOFTWARE PROGRAM TO OPTIMAL CORES

(71) Applicant: The Toronto-Dominion Bank, Toronto (CA)

(72) Inventors: Peter Starszyk, Waterloo (CA); Devinder Kumar, Toronto (CA); Wen-Yang Ku, Toronto (CA); Maksims Volkovs, Toronto (CA)

(73) Assignee: The Toronto-Dominion Bank, Toronto (CA)

(21) Appl. No.: 18/813,608

(22) Filed: Aug. 23, 2024

(51) Int. Cl. G06F 9/50

(52) U.S. Cl. CPC G06F 9/5055

(57) ABSTRACT

An example operation may include one or more of executing a software application on a plurality of different cores, identifying runtime attributes of the plurality of different cores while executing the software application, identifying current processing loads of the plurality of different cores, adding a weight to the runtime attributes of the plurality of different cores to generate weighted runtime attributes, assigning the software application to a subset of cores from among the plurality of different cores based on the weighted runtime attributes and the current processing loads of the plurality of different cores, and updating the executing of the software application to execute the software application via the subset of cores. An artificial intelligence (AI) model can be trained and/or executed when performing at least one portion of the example operation.

### BACKGROUND

To optimize performance of software that executes on a multi-core processor, common approaches focus on infrastructure choices like choosing faster processing cores and default tuning parameters offered by frameworks and libraries. For software that includes an artificial intelligence (AI) model, the performance of the software can also be optimized by reducing model complexity. However, when software is expected to experience irregular workloads (e.g., fluctuating loads, fluctuating arrival rates, etc.), optimizing runtime of the multi-core processor becomes more complex. In this case, traditional optimization approaches may increase performance of the software for some load patterns while degrading performance of the software for other load patterns.

### SUMMARY

One example embodiment provides an apparatus that includes a memory communicably coupled to a processor, wherein the processor may one or more of run an optimization module on an optimizer host, assign, by the optimizer host, a software application to at least one core from among a plurality of cores of a server host, instruct, by the optimizer host, the server host to process the software application using the at least one core assigned to the software application, determine, by the optimizer host, runtime attributes of the software application while it is executing on the at least one core based on data fed back from the server host, dynamically re-assign, by the optimization module, the software application to at least one different core from among the plurality of cores of the server host based on the runtime attributes, and re-instruct, by the optimizer host, the server host to execute the software application on the at least one different core instead of the at least one core.

Another example embodiment provides a method that includes one or more of running an optimization module on an optimizer host, assigning, by the optimizer host, a software application to at least one core from among a plurality of cores of a server host, instructing, by the optimizer host, the server host to process the software application using the at least one core assigned to the software application, determining, by the optimizer host, runtime attributes of the software application while it is executing on the at least one core based on data fed back from the server host, dynamically re-assigning, by the optimization module, the software application to at least one different core from among the plurality of cores of the server host based on the runtime attributes, and re-instructing, by the optimizer host, the server host to execute the software application on the at least one different core instead of the at least one core.

A further example embodiment provides a computer readable storage medium comprising instructions, that when read by a processor, cause the processor to perform one or more of running an optimization module on an optimizer host, assigning, by the optimizer host, a software application to at least one core from among a plurality of cores of a server host, instructing, by the optimizer host, the server host to process the software application using the at least one core assigned to the software application, determining, by the optimizer host, runtime attributes of the software application while it is executing on the at least one core based on data fed back from the server host, dynamically re-assigning, by the optimization module, the software application to at least one different core from among the plurality of cores of the server host based on the runtime attributes, and re-instructing, by the optimizer host, the server host to execute the software application on the at least one different core instead of the at least one core.

One example embodiment provides an apparatus that includes a memory communicably coupled to a processor, wherein the processor may one or more of execute a software application via a plurality of cores of a server host, test the software application while executing the software application via the plurality of cores of the server host, capture runtime attributes of the software application based on the test, determine, via an optimizer, an optimal subset of cores for executing the software application from among the plurality of cores of the server host based on the runtime attributes of the software application, dynamically assign, via the optimizer, the software application to the optimal subset of cores, and modify the server host to execute the software application on the optimal subset of cores.

Another example embodiment provides a method that includes one or more of executing a software application via a plurality of cores of a server host, testing the software application while executing the software application via the plurality of cores of the server host, capturing runtime attributes of the software application based on the testing, determining, via an optimizer, an optimal subset of cores for executing the software application from among the plurality of cores of the server host based on the runtime attributes of the software application, dynamically assigning, via the optimizer, the software application to the optimal subset of cores, and modifying the server host to execute the software application on the optimal subset of cores.

A further example embodiment provides a computer readable storage medium comprising instructions, that when read by a processor, cause the processor to perform one or more of executing a software application via a plurality of cores of a server host, testing the software application while executing the software application via the plurality of cores of the server host, capturing runtime attributes of the software application based on the testing, determining, via an optimizer, an optimal subset of cores for executing the software application from among the plurality of cores of the server host based on the runtime attributes of the software application, dynamically assigning, via the optimizer, the software application to the optimal subset of cores, and modifying the server host to execute the software application on the optimal subset of cores.

One example embodiment provides an apparatus that includes a memory communicably coupled to a processor, wherein the processor may one or more of execute a software application on a plurality of different cores, identify runtime attributes of the plurality of different cores while executing the software application, identify current processing loads of the plurality of different cores, add a weight to the runtime attributes of the plurality of different cores to generate weighted runtime attributes, assign the software application to a subset of cores from among the plurality of different cores based on the weighted runtime attributes and the current processing loads of the plurality of different cores, and update the executing of the software application to execute the software application via the subset of cores.

Another example embodiment provides a method that includes one or more of executing a software application on a plurality of different cores, identifying runtime attributes of the plurality of different cores while executing the software application, identifying current processing loads of the plurality of different cores, adding a weight to the runtime attributes of the plurality of different cores to generate weighted runtime attributes, assigning the software application to a subset of cores from among the plurality of different cores based on the weighted runtime attributes and the current processing loads of the plurality of different cores, and updating the executing of the software application to execute the software application via the subset of cores.

A further example embodiment provides a computer readable storage medium comprising instructions, that when read by a processor, cause the processor to perform one or more of executing a software application on a plurality of different cores, identifying runtime attributes of the plurality of different cores while executing the software application, identifying current processing loads of the plurality of different cores, adding a weight to the runtime attributes of the plurality of different cores to generate weighted runtime attributes, assigning the software application to a subset of cores from among the plurality of different cores based on the weighted runtime attributes and the current processing loads of the plurality of different cores, and updating the executing of the software application to execute the software application via the subset of cores.

### BRIEF DESCRIPTION OF DRAWINGS

FIG. 1A is a diagram illustrating a system for optimizing an assignment of processing cores to a software program according to examples and features of the instant solution.

FIGS. 1B-1C are diagrams illustrating a process of updating processing cores which are assigned to a software application according to examples and features of the instant solution.

FIGS. 2A-2D are diagrams illustrating a process of modifying processing cores assigned to a software application by default according to the examples and features of the instant solution.

FIGS. 3A-3C are diagrams illustrating a process of testing a software application on a plurality of processing cores and optimizing an assignment of the software application according to examples and features of the instant solution.

FIGS. 4A-4C are diagrams illustrating a process of assigning processing cores to a software application based on weighted runtime attributes according to examples and features of the instant solution.

FIGS. 5A-5B are diagrams illustrating a method of dynamically re-assigning processing cores to a software application based on runtime attributes according to examples and features of the instant solution.

FIGS. 6A-6B are diagrams illustrating a method of stress testing processing cores and assigning a software application to an optimal subset of cores based on the stress testing according to examples and features of the instant solution.

FIGS. 7A-7B are diagrams illustrating a method of weighting runtime attributes of a plurality of processing cores and assigning a software application to a subset of cores based on the weighted runtime attributes according to examples and features of the instant solution.

FIG. 8 is a system diagram illustrating a computing environment according to the instant solution's example features, structures, or characteristics.

### DETAILED DESCRIPTION

Traditionally, a multi-core processing system uses runtime attributes of the processing cores (such as current load of the processing cores) to determine an optimal assignment of a software application to a particular subset of cores. Here, the multi-core processing system may rely on a scheduler (e.g., of an operating system, etc.), a load balancer, etc. to perform “load balancing” among the different cores of the multi-core processing system. In this type of processing scenario, the “load” of a software application may be distributed to different cores in an attempt to evenly distribute processing load amongst the different cores of the multi-core processing system.

The examples and features of the instant solution are directed to an optimization system that can optimize performance of a software program as it executes on a multi-core processing system such as a mainframe, a cloud platform, a web server, a database, and the like. The optimization system may not rely on a scheduler or a load balancer to select the core or subset of cores for processing a program. Instead, the optimization system may use attributes (e.g., runtime attributes, etc.) of the threads of the software program as it runs on the multi-core processing system to determine an affinity of the software program with respect to the multi-core processing system.

The software program may be executed on a multi-core processing system on a server host (or just host). The software program may initially execute on multiple different cores (e.g., all cores, a particular set of cores, etc.) within the multi-core processing system. The optimizer system may be hosted on an optimizer host which is external from the server host. During the initial execution, the optimizer host may communicate with the server host to test the performance of the software program as it executes on the multiple different cores and obtain runtime attributes of the software program from the testing. The optimizer system may use the runtime attributes of the performance of the multiple different cores as the software program is executed to select an optimal subset of cores of the multi-core processing system for future executions of the software program and assign the software program (e.g., pin the threads of the software program, etc.) to the optimal subset of cores.

In some examples and features of the instant solution, the optimal affinity assignment of the software program may be determined regardless of current processing load of the different processing cores or in addition to the current processing load of the different processing cores. That is, the optimizer system may determine the optimal affinity of the software program using the runtime attributes of the software instead of the processing loads. Furthermore, the affinity assignment may be performed by an optimizer that is running on an external system (e.g., the optimizer host) that is independent of the server host where the multi-core processing system is located. The optimizer host system may reduce the use of a scheduler for the multi-core processing system to determine the optimal subset of cores.

The instant solution offers improvements in computer systems, specifically enhancing the efficiency and performance of multi-core processors during software application execution. Traditionally, multi-core processors rely heavily on operating system schedulers and load balancers to distribute workloads across cores, aiming to optimize performance by balancing processing loads. However, this approach needs to account for the unique performance characteristics of individual cores, particularly under varying and fluctuating workloads, which can lead to suboptimal utilization of processing resources.

The instant solution addresses this limitation by introducing an advanced optimization system that dynamically assigns software applications to the optimal subset of cores based on real-time runtime attributes independent of current processing loads. This system improves the overall computational efficiency by leveraging an external optimizer host, which continuously monitors and analyzes the performance metrics of each core. Thus, the solution ensures that software applications are executed on cores that perform best for specific tasks rather than merely distributing workloads based on general load-balancing algorithms.

The system's ability to dynamically reassign applications to different cores without interrupting execution marks an advancement in maintaining continuity and minimizing downtime. This migration capability is beneficial in environments with fluctuating workloads, where the performance characteristics of cores may change rapidly. The result is a more responsive and adaptive computing environment that maximizes multi-core systems' throughput and processing speed.

The system implements a dynamic thread-to-core affinity management framework that adapts in real time to the varying workload patterns encountered by software applications, particularly machine learning models. The software application is initially assigned to a default set of cores within a multi-core processor. As the application executes, the system continuously monitors runtime attributes such as core utilization, processing latency, and throughput. These attributes are fed back to an external optimizer host, which analyzes the data and dynamically adjusts the affinity of threads to cores. This adjustment is based on a black-box optimization approach that considers current performance metrics and the anticipated workload patterns.

During periods of low demand, the system may consolidate threads onto fewer cores to reduce contention and improve efficiency. Conversely, during peak processing times, such as batch processing of large datasets, the system redistributes threads across multiple cores to maximize parallelism and reduce processing time. This adaptability ensures that the application maintains optimal performance regardless of workload fluctuations.

The system further integrates customizable machine learning inference pipelines, allowing engineers to specify and modify the components of the pipeline through configuration files. This flexibility enables the optimization framework to be tailored to the specific needs of different applications, ensuring that the thread-to-core assignments are optimized not only based on core performance but also in alignment with the unique requirements of the pipeline components, which may be beneficial for applications that involve complex preprocessing or feature engineering tasks that may have different computational demands.

The system includes a fault-tolerant logging mechanism that ensures the reliable capture and storage of runtime attributes and performance metrics. This logging system operates asynchronously to prevent interference with the primary processing tasks. In the event of a failure in the logging system, a fallback mechanism ensures that all critical data is preserved, allowing the optimizer to continue making informed decisions about core assignments even under suboptimal conditions.

The system enables seamless migration of software applications between cores without interrupting execution. When the optimizer identifies a core that can perform better based on the latest runtime attributes, it can dynamically reassign the application to this core. The migration does not require restarting the application, ensuring continuous operation. The system can pin threads to specific cores for future executions, optimizing long-term performance based on historical data and ongoing analysis.

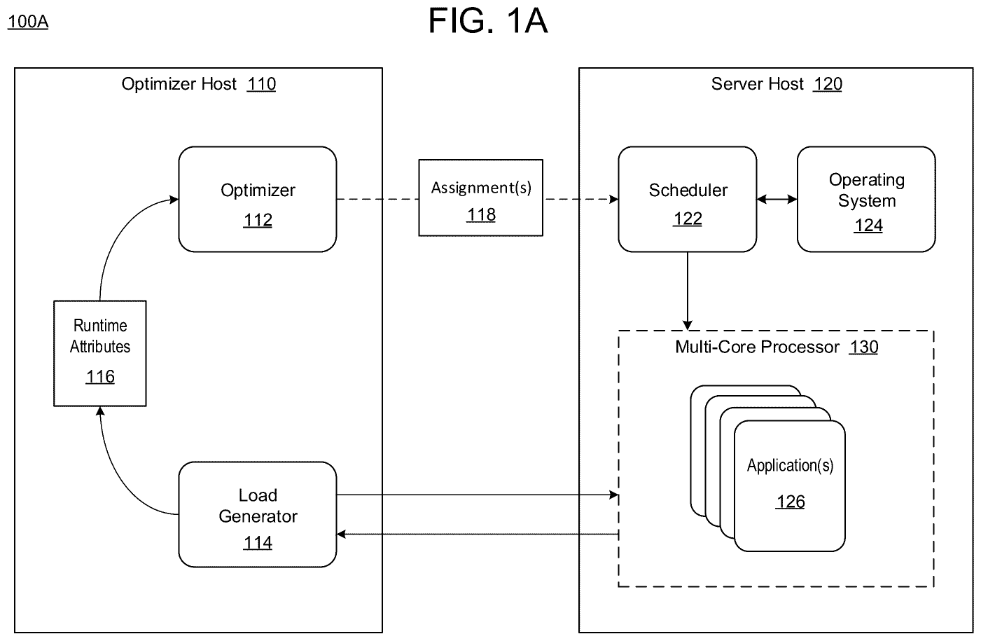

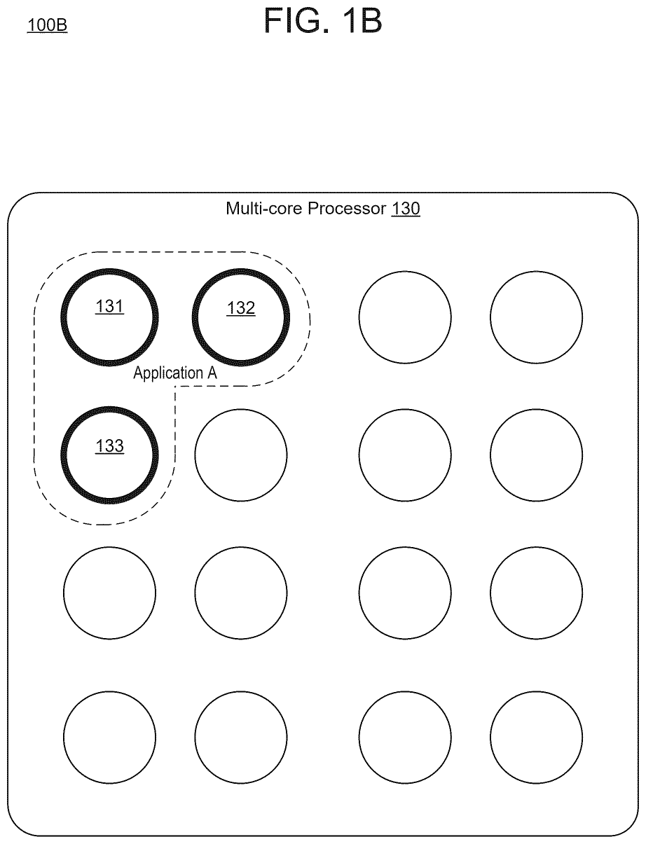

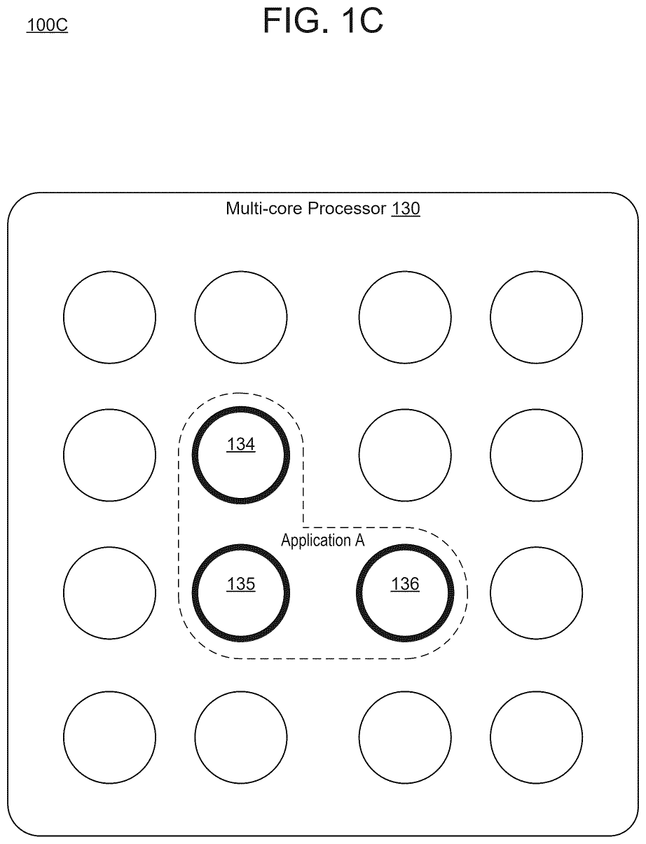

FIG. 1A illustrates an optimization system 100A for optimizing an assignment of processing cores to a software program according to examples and features of the instant solution. Referring to FIG. 1A, the optimization system 100A includes a server host 120 with a multi-core processor 130 consisting of a plurality of processing cores. The server host 120 may be a web server, a cloud platform, a database, a mainframe, and the like. The optimization system 100A also includes an optimizer host 110 that hosts an optimizer 112 configured to optimize assignments of software to cores within the multi-core processor 130 on the server host 120. As an example of the instant solution, the optimizer host 110 may be a different node, server, virtual machine, etc. with respect to the server host 120. The optimizer host 110 and the server host 120 may communicate through a channel of communication that is established over a computer network. As another example of the instant solution, the optimizer host 110 and the server host 120 may communicate through a local channel, such as two systems inside the same pod of a server, etc.

In this example of the instant solution, the server host 120 includes a scheduler 122 that may be configured to schedule/manage which cores of the multi-core processor 130 are used to execute a software program or application. The scheduler 122 may interact with and schedule the threads of a software program or application to execute on the cores of the multi-core processor 130. The server host 120 also includes an operating system 124 which manages the scheduler 122 and the multi-core processor 130. In this example of the instant solution, the scheduler 122 and/or the operating system 124 may schedule threads and allocate processor cores and time for execution to ensure that programs run on the multi-core processor 130 without conflicts.

According to various examples and features of the instant solution, the scheduler 122 may receive instructions from the optimizer 112 on which core or cores of the multi-core processor 130 to use to execute a software program or application. That is, rather than the scheduler 122 deciding which cores to use to execute a software program or application, the scheduler 122 receives instructions from the optimizer 112 which instruct the scheduler 122 which cores of the multi-core processor 130 to use to execute the software program or application. Here, the optimizer 112 may initially assign a software program or application to a default core or subset of cores within the multi-core processor 130. As another example of the instant solution, the optimizer 112 may request that the scheduler 122 schedules the multi-core processor 130 to simulate a software program or application on some or all of the cores of the multi-core processor 130.

In the example of FIG. 1A, one or more software applications 126 are being executed by the multi-core processor 130. Here, the one or more applications 126 may be initially assigned to cores within the multi-core processor 130 based on default assignments from the optimizer 112. As the one or more software applications 126 execute, the multi-core processor 130 may transfer runtime attributes 116 of the one or more software applications 126 to a load generator module 114 on the optimizer host 110. Here, the load generator module 114 may transfer the runtime attributes 116 to the optimizer 112. The runtime attributes 116 may include processing time (e.g., elapsed time) that it takes for certain tasks to be performed by a core. As another example of the instant solution, the runtime attributes 116 may include throughput, current processing load, efficiency statistics, and the like.

According to various examples and features of the instant solution, the optimizer 112 may receive the runtime attributes 116 from the multi-core processor 130 and may use the runtime attributes 116 to dynamically re-assign or assign the one or more software applications 126 to one or more cores within the multi-core processor 130 based on the performance of the processing cores within the multi-core processor 130 executing the one or more software applications 126. Here, the optimizer 112 generates a dynamic assignment 118 of a software application based on the runtime attributes 116 and provides the dynamic assignment 118 to the scheduler 122. In response, the scheduler may move a software application from a first core or subset of cores to a second core or subset of cores in a seamless manner. As another example of the instant solution, the scheduler 122 may wait for future executions of the software application and execute the future executions of the software application on the affinity assignment included in the dynamic assignment 118.

The same process may be iteratively repeated. The subset of optimal cores for processing a software application may be updated based on the runtime attributes of the software application (and other software applications). The system can use the tasks that are performed by a particular software application and the runtime attributes of such tasks when they are processed using different cores of the multi-core processor 130 to identify an optimal core or subset of cores within the multi-core processor 130 for executing such tasks. Thus, the software application can be pinned to the optimal core of subset of cores using runtime attributes of the software, regardless of or in addition to the current processing load of the different cores of the multi-core processor 130. In this way, threads of a software application can be processed using an optimal core or subset of cores that have a greater load than other cores. In other words, the load balancing and/or utilization of a core may receive less weight or no weight in this situation. Instead, the optimizer 112 may consider the runtime attributes of the software application at each of the cores when executing the software and may add a greater weight to the core performance in comparison.

For example, fluctuations in processing load can cause a processing core to behave differently/less efficient. This may not happen to each of the cores in the multi-core processor. Therefore, these types of loads can cause incongruencies among the different cores while processing the same software. For example, a first core may handle batch processing more efficiently than a second core, while the second core may handle individual transaction processing more quickly than the second core.

FIGS. 1B-1C illustrate a process of updating processing cores which are assigned to a software application according to examples and features of the instant solution. For example, FIG. 1B illustrates a process 100B of assigning a software application (Application A) to a first subset of processing cores 131, 132, and 133 of the multi-core processor 130. Here, the assignment of the first subset of processing cores 131, 132, and 133 may be performed based on a default assignment provider by the optimizer 112 shown in FIG. 1A. The default assignment may be based on an assignment set by a developer, an administrator, metadata within the software application, or the like. As another example of the instant solution, the default assignment may be based on load balancing.

The runtime attributes of the software application running on the first subset of cores 131, 132, and 133 may be captured by the system and fed back to the optimizer 112 shown in FIG. 1A. Here, the optimizer 112 may also receive runtime attributes of the other cores within the multi-core processor 130 as they execute the same software or similar software, over time. Each of the tasks performed by the software may also be provided to the optimizer 112, enabling the optimizer 112 to understand how each core performs on each different type of task. As more data is made available, the optimizer 112 may determine in real time or near real time that the software application (Application A) has optimal runtime performance compared to a different subset of cores.

FIG. 1C illustrates a process 100C of migrating the software application from the first subset of cores 131, 132, and 133 to a second subset of cores 134, 135, and 136 of the multi-core processor 130. Here, the migration process may be seamlessly performed through the scheduler 122 by allowing the software application to start on the second subset of cores 134, 135, and 136, before stopping execution of the software application on the first subset of cores 131, 132, and 133. The scheduler 122 may manage connections of the software application so that they point to the new version of the software application corresponding to the new assignment (the second subset of cores 134, 135, and 136) prior to terminating the execution of the software application on the first subset of cores 131, 132, and 133.

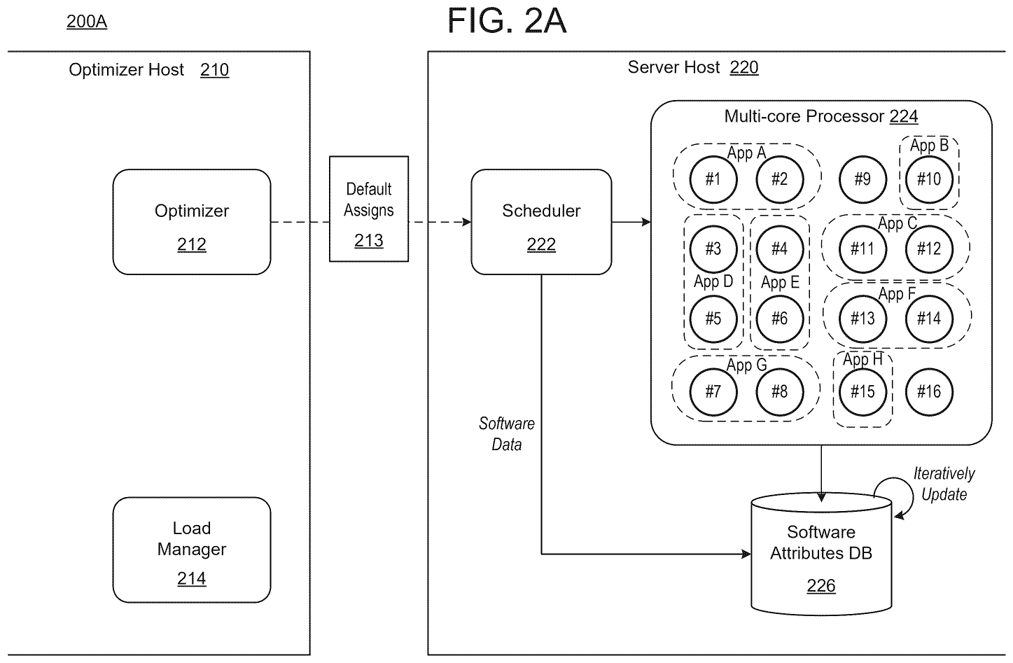

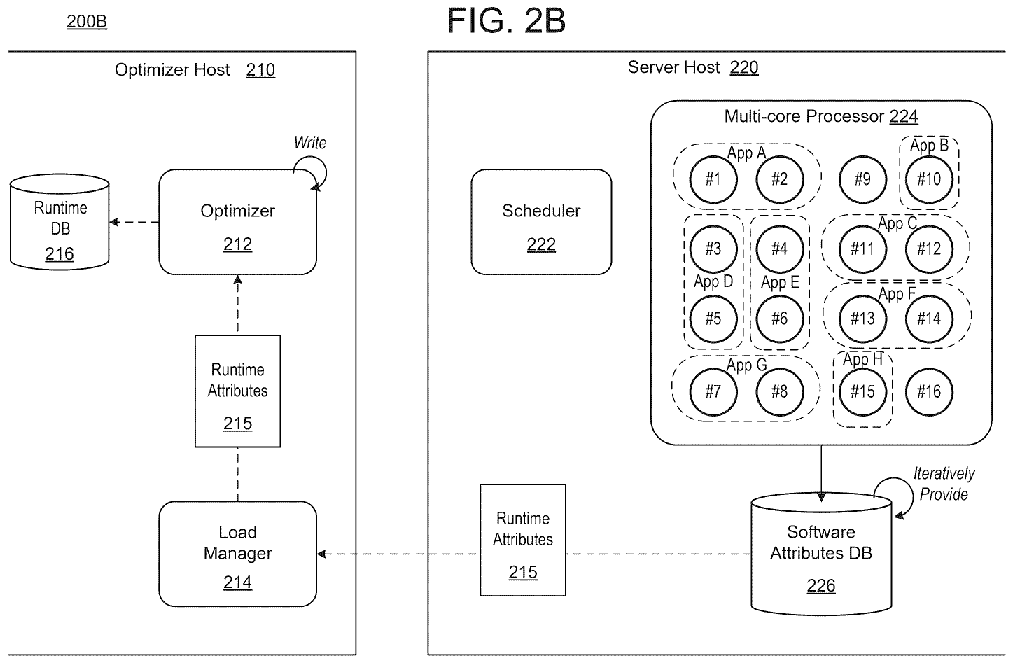

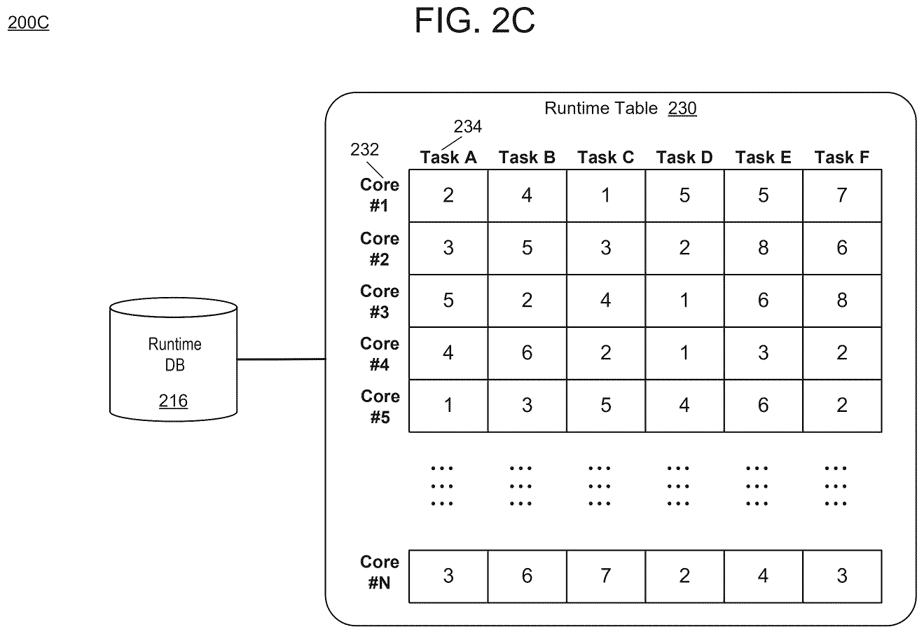

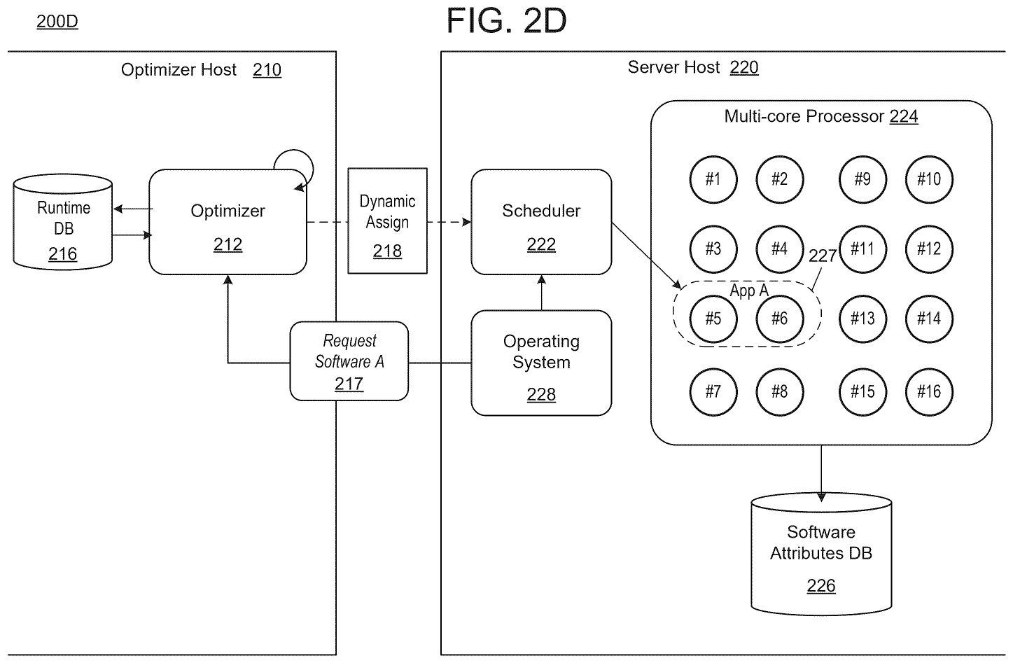

FIGS. 2A-2D illustrate a process of modifying processing cores assigned to a software application by default according to the examples and features of the instant solution. For example, FIG. 2A illustrates a process 200A of assigning software to processing cores of a multi-core processor 224 based on default assignments 213 of the software. In this example of the instant solution, the software refers to software applications, but it should be appreciated that the examples may be used with any type of software program.

Referring to FIG. 2A, a server host 220 includes a multi-core processor 224 configured to execute software on various processing cores and a scheduler 222 configured to schedule the software to execute on the cores including times, etc. Although not shown, the server host 220 may also include an operating system that receives requests to execute software and provides the requests to the scheduler 222 for execution on the multi-core processor 224. Each software (such as a software application) may be executed across a plurality of threads. The system also includes an optimizer host 210 that is connected to the server host through a channel. In this example of the instant solution, the optimizer host 210 may be a separate server, separate node, separate virtual machine, etc. that is network-connected to the server host 220.

In this example of the instant solution, requests to execute software are provided to the scheduler 222 of the multi-core processor 224, for example, from an operating system (not shown). In response, the scheduler 222 may schedule the software to execute on cores of the multi-core processor 224 based on default instructions (the default assignments 213) from an optimizer 212. The default assignments 213 may be set by a developer, by an administrator, based on load balancing, based on metadata of the software, and the like. The scheduler 222 may cause the software to execute on the assigned cores of the multi-core processor 224. In this example of the instant solution, the optimizer 212 is running on an optimizer host 210 which may be a different node from the server host 220 where the multi-core processor 224 is located. The processing cores of the multi-core processor 224 may execute different software in parallel (i.e., simultaneously).

The multi-core processor 224 may capture performance data such as statistics, metrics, and the like, of the processing cores within the multi-core processor 224 as they execute the different software applications and store the metrics and statistics in a software attributes database 226. In addition to storing the performance data, the scheduler 222 and/or the multi-core processor 224 may store identifiers of the type of software being executed by each of the cores. The performance data may include an elapsed amount of time that it takes for a core to execute a particular type of task. The tasks may include different types such as, but not limited to, machine learning tasks, image processing tasks, compiling tasks, rendering tasks, data analysis tasks, database transactions, audio processing tasks, and the like. The software attributes database 226 may store the software data (e.g., performance data of the software, identifiers of the type of software executed, tasks performed by the software, etc.) of each core along with types of tasks being performed by each core. In addition, the software attributes database 226 may be iteratively updated.

FIG. 2B illustrates a process 200B of transferring the software attributes from the software attributes database 226 to the optimizer 212 according to examples and features of the instant solution. Referring to FIG. 2B, the software attributes database 226 may be queried by a load manager 214 running on the optimizer host 210. The load manager 214 may receive runtime attributes 215 (e.g., performance data of the processing cores of the multi-core processor 224 and types of task/software being executed by the processing cores of the multi-core processor 224) from the software attributes database 226. Upon receiving the runtime attributes 215 from the server host 220, the load manager 214 may forward the runtime attributes 215 to the optimizer 212 for future assignments of the software. In this example of the instant solution, the optimizer 212 may include a runtime database 216 or other storage (cache, etc.) which stores the runtime attributes 215 of the different processing cores including performance data and task types.

In some examples and features of the instant solution, the process may be iteratively repeated. As the processing cores execute different types of software, the performance data (runtime attributes) may be captured and stored within the software attribute database 226. Furthermore, the runtime attributes 215 may be provided to the load manager 214 enabling the optimizer 212 to have the most up-to-date metrics, statistics, etc. of the different processing cores of the multi-core processor 224. For example, the optimizer 212 may write the runtime attributes 215 to the runtime database 216.

FIG. 2C illustrates a process 200C of accessing a runtime table 230 within the runtime database 216 with runtime attributes of the processing cores of the multi-core processor 224, and FIG. 2D illustrates a process 200D of dynamically assigning a software application to an optimal subset of cores of the multi-core processor 224 based on the runtime attributes stored in the runtime database 216 according to examples and features of the instant solution. Referring to FIGS. 2C and 2D, the optimizer 212 may receive a request 217 to execute a software application (software A) from an operating system 228 of the server host 220. The operating system 228 may also provide a similar request to the scheduler 222 which instructs the scheduler to schedule the software for processing by the multi-core processor 224.

In this example of the instant solution, the optimizer 212 may receive the request 217 and analyze the runtime table 230 shown in FIG. 2C to identify an optimal core or subset of cores within the multi-core processor 224 for processing the software. Here, the request 217 may identify a type of the software application including task types, etc. As another example of the instant solution, the optimizer 212 may detect the task types based on previously stored data within the runtime database 216. Here, the optimizer 212 may identify how many cores to use based on a thread count, or the like, of the software application, and may identify which cores to use based on the performance data within the runtime database 216. The optimizer 212 may determine in real time or near real time an optimal subset of cores for performing the tasks of the software efficiently and then assign the software to the optimal subset of cores.

In the example of FIG. 2C, the runtime table includes a two-dimensional array of metrics with identifiers of processing cores on a first dimension 232 and identifiers of task types on a second dimension 234 within the runtime table 230. Here, the optimizer 212 may quickly identify which cores perform the tasks most efficiently and dynamically assign the software application to these cores. The assignment may be a re-assignment (dynamic assignment, etc.).

Referring to FIG. 2D, the optimizer 212 provides a dynamic assignment 218 to the scheduler 222 which identifies the optimal subset of cores assigned to the software application. In response, the scheduler may schedule the application for execution on the optimal subset of cores 227.

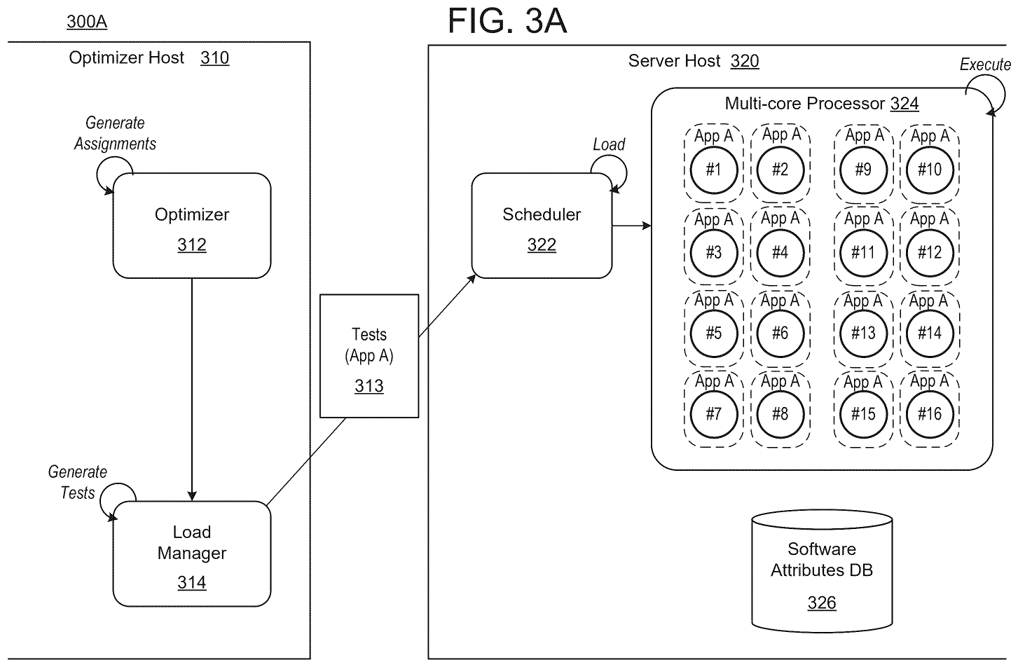

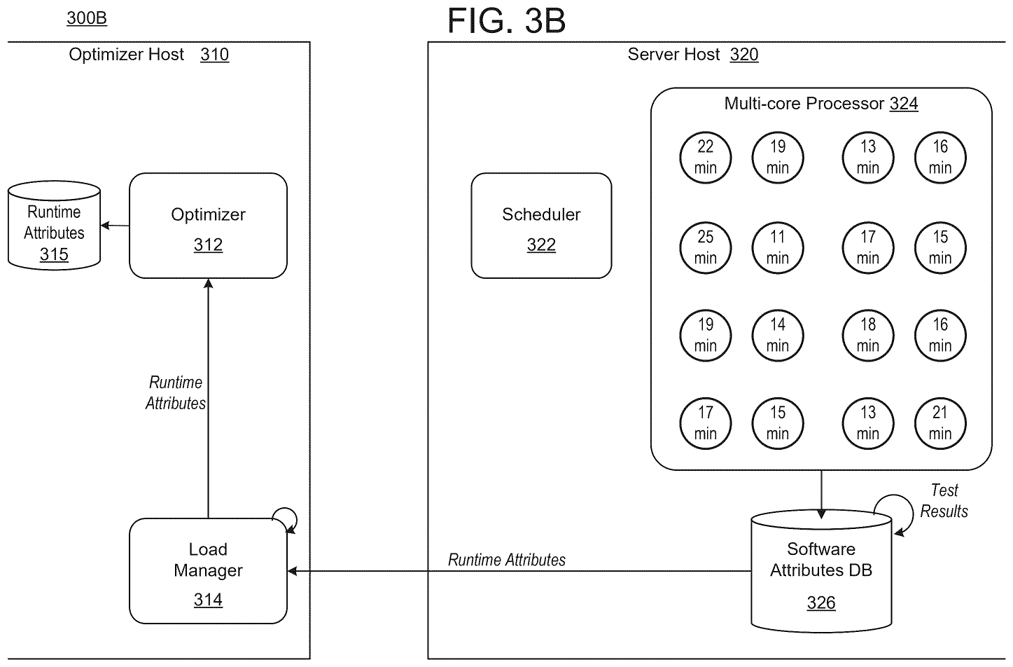

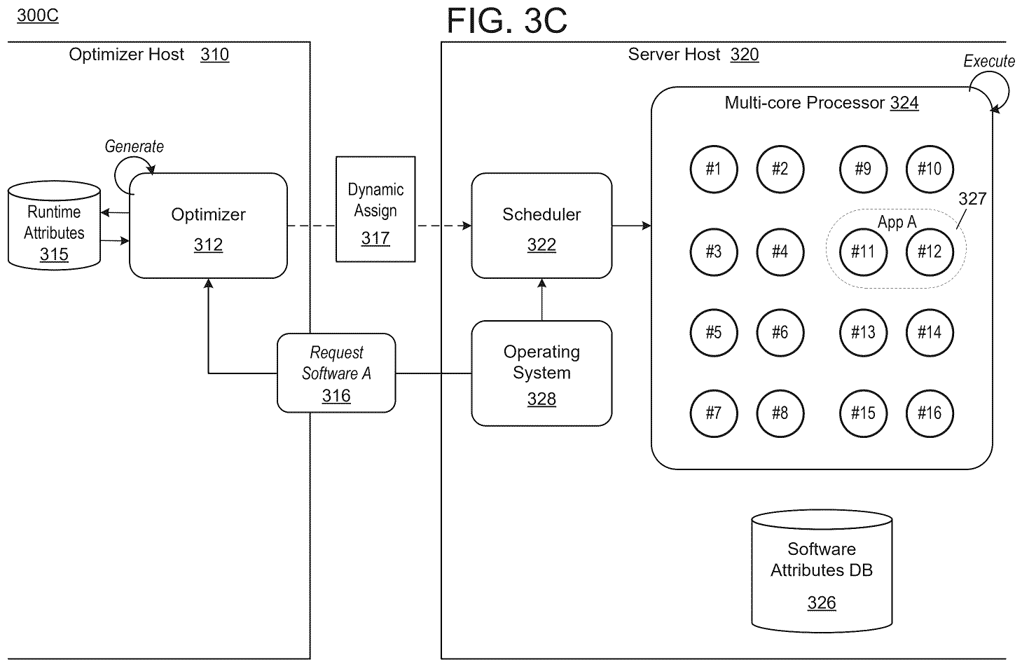

FIGS. 3A-3C illustrate a process of testing a software application on a plurality of processing cores and optimizing an assignment of the software application according to examples and features of the instant solution. For example, FIG. 3A illustrates a process 300A of testing a software application (e.g., threads, etc.) on different cores of a multi-core processor 324 to determine runtime attributes of the different cores when performing the tasks of the software application. In this example of the instant solution, a server host 320 hosts a multi-core processor 324 for executing software applications. Meanwhile, an optimizer host 310 hosts an optimizer 312 for optimizing and generating assignments of software on the cores of the multi-core processor 324.

Referring to FIG. 3A, a load manager 314 that is also deployed on the optimizer host 310 may generate tests 313 for testing the execution of a software application (for example, App A) on different cores of the multi-core processor 324. The tests may be generated prior to deployment of the software application. As another example of the instant solution, the tests 313 may be generated during development of the software application (for example, App A). The tests 313 may identify tasks of the software application that are to be executed, cores which are to execute the tasks, a duration of the tasks, whether the tasks are to be completed or are to be stopped after a predetermined amount of time, data to be used for the tasks, and the like. The tests 313 for the software may be generated by the load manager 314. Here, the tests 313 may be generated based on instructions provided from a developer, an administrator, and the like. As another example of the instant solution, the instructions may be generated based on default instructions that are automatically used by the load manager 314 to test all software.

In this example of the instant solution, the load manager 314 generates tests 313 which include the same task to be performed by each of the cores of the multi-core processor 324 and forwards the tests 313 to a scheduler 322. In response to receiving the tests 313, the scheduler 322 schedules execution (e.g., simulation, etc.) of the software application on each of the cores of the multi-core processor 324 for an amount of time. In response, the software is loaded onto each of the cores of the multi-core processor 324 and executed by the cores of the multi-core processor 324.

FIG. 3B illustrates a process 300B of capturing runtime attributes of the plurality of cores of the multi-core processor 324 performing the tests that are provided in the example of FIG. 3A. Here, the different cores may perform tasks/execute threads of the software application and metrics or other performance data may be captured on a core-by-core basis. In this example of the instant solution, the metric is “elapsed time”, however, different metrics may be used. For example, the elapsed time may refer to how much processing time it takes to finish a particular task. As an example, the task may refer to multiple iterations of a machine learning pipeline which includes a sequence of operations being performed to generate a predictive output.

The runtime attributes of the processing cores of the multi-core processor 324 performing the tests may be written to a software attributes database 326. The runtime attributes may be transferred to the load manager 314 or otherwise queried by the load manager 314 on the optimizer host 310. The load manager 314 may also provide the runtime attributes to the optimizer which stores the runtime attributes within a runtime attributes database 315, such as a cache or the like. Similar tests may be performed for different tasks, different software programs, applications, etc. and stored within the runtime attributes database 315. As such, the runtime attributes created by the tests can be used by the optimizer 312 when a subsequent request to execute a particular software program is received (e.g., during deployment, etc.)

FIG. 3C illustrates a process 300C of dynamically assigning a software application to an optimal subset of cores of the multi-core processor 324 based on the runtime attributes from the testing which are stored in the runtime attributes database 315 according to examples and features of the instant solution. Referring to FIG. 3C, the optimizer 312 may receive a request 316 to execute a software application (software A) from an operating system 328 of the server host 320. The operating system 328 may also provide a similar request to the scheduler 322 which instructs the scheduler 322 to schedule the software for processing by the multi-core processor 324.

In this example of the instant solution, the optimizer 312 may receive the request 316 and analyze the statistics from the testing of the software application (previously performed) to identify an optimal core or subset of cores within the multi-core processor 324 for processing the software. Here, the request 316 may include an identifier of the software application and the runtime attributes stored within the runtime attributes database 315. Thus, the optimizer 312 can quickly identify in real time or near real time which core(s) is the most optimal core or subset of cores based on the runtime attributes within the runtime attributes database 315.

For example, the optimizer 312 may identify how many cores to use based on a thread count, or the like, of the software application, and may identify which cores to use based on the performance data within the runtime attributes database 315. The optimizer 312 may determine in real time or near real time an optimal subset of cores 327 for performing the tasks of the software efficiently, and then assign the software to the optimal subset of cores 327. Further, a dynamic assignment 317 may be provided by the optimizer 312 to the scheduler 322 of the server host which instructs the scheduler to load the application onto the optimal subset of cores 327.

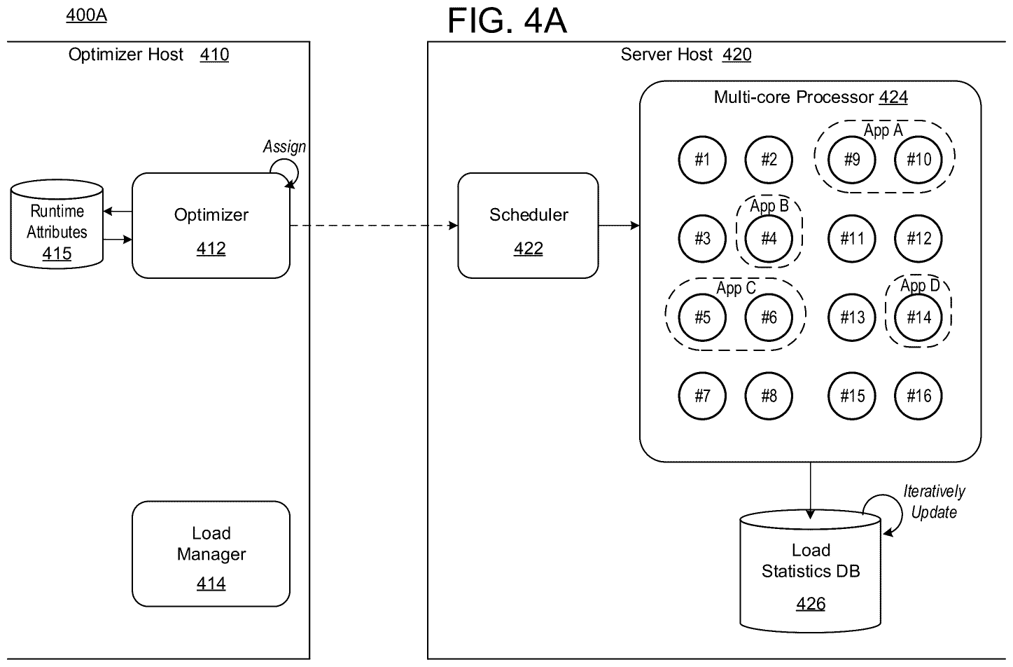

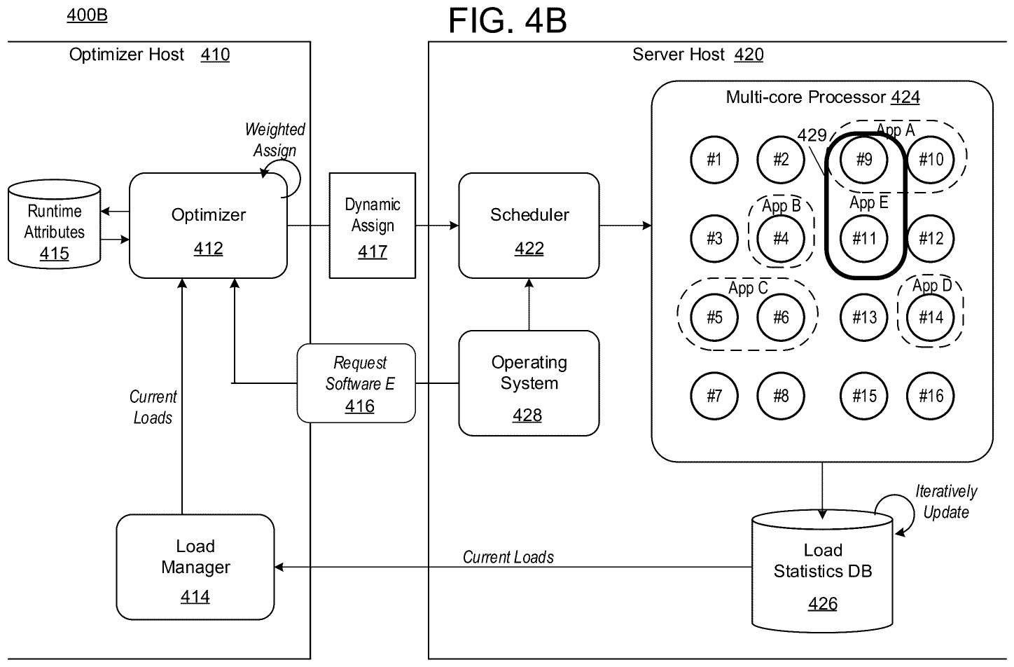

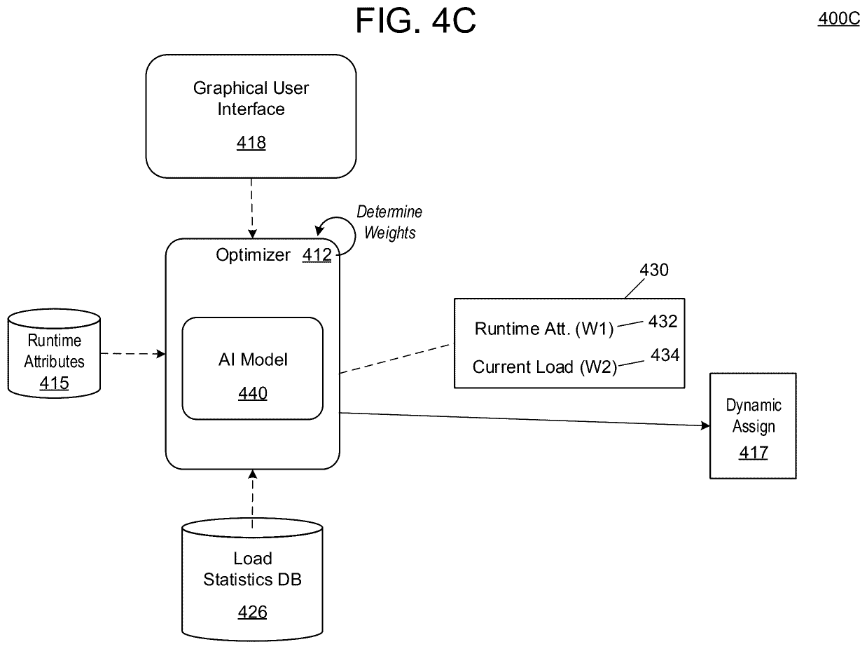

FIGS. 4A-4C illustrate a process of assigning processing cores to a software application based on weighted runtime attributes according to examples and features of the instant solution. In these examples, the runtime attributes of a particular software application and the current load of the multi-core processor are considered when determining an optimal subset of cores for executing the software application. This process may be performed after the runtime attributes database 415 has been generated and includes runtime attributes of the software application. Here, the runtime attributes database 415 may correspond to the performance of a software application on different processing cores within a multi-core processor 424.

For example, FIG. 4A illustrates a process 400A of generating current load statistics of each processing core of the multi-core processor 424 and storing the load data in a load statistics database 426. In the example of FIG. 4A, a server host 420 may include the multi-core processor 424 for executing/hosting software programs such as software applications and the load statistics database 426. In addition, the server host 420 may execute a scheduler 422 of the multi-core processor 424. The scheduler 422 may be responsible for scheduling threads of software for execution by the processing cores within the multi-core processor 424. In this example of the instant solution, a processing core usage (ratio, etc.) may be determined in real-time and provided to the load statistics database 426, and the load statistics database 426 may be updated iteratively.

Meanwhile, an optimizer host 410 hosts an optimizer 412 for optimizing assignments of software to the processing cores of the multi-core processor 424. Here, the optimizer 412 may receive a notification that a software application is being executed and may determine in real time or near real time the optimal subset of cores within the multi-core processor 424 for processing the software application based on the runtime attributes of the software application stored in the database of runtime attributes and current processing load statistics from the multi-core processor 424.

In the example of FIG. 4A, software applications may already be running on cores of the multi-core processor 424. In this example of the instant solution, the cores within the multi-core processor 424 may have fluctuating workloads/loads which can be captured in real-time (i.e., current processing loads) and recorded in a load statistics database 426. The current processing loads may include the current utilization rate of each of the processing cores which may be determined based on an amount of computational work/tasks performed by the respective processing cores over a predetermined period of time, and the like. For example, the current processing load may represent the average processing load of a processing core for the last hour, last 30 minutes, last minute, or the like. The load statistics database 426 may be updated continuously (e.g., at a predetermined frequency) so as to capture the utilization rate of the processing cores as they change over time.

FIG. 4B illustrates a process 400B of determining an optimal subset of cores for processing a software application based on a combination of runtime attributes of the software application and current processing load statistics of the processing cores in the multi-core processor 424. Here, the current processing load data may be retrieved from the load statistics database 426 by a load manager 414 on the optimizer host 410 and provided to the optimizer 412. Thus, the optimizer 412 may receive the runtime attributes of a software application from the runtime attributes database 415 and also receive load data representing current processing loads of the plurality of cores of the multi-core processor 424 from the load statistics database 426.

In FIG. 4B, an operating system 428 of the server host 420 requests execution of a software application E and sends a request 416 to the optimizer 412 and to the scheduler 422. In response, the optimizer 412 may determine in real time or near real time an optimal subset of cores for processing a software application based on a combination of the current processing load data and the runtime statistics of the software application. For example, the optimizer 412 may apply weights to the current processing load data and the runtime attributes of the software application and determine which core or cores are most optimal at a particular time based on the current processing load data, the runtime statistics, and the weights applied to each.

For example, a machine learning model, an artificial intelligence model, or the like, may be trained to identify an optimal core based on a combination of processing load and runtime attributes. In response, the optimizer 412 may dynamically assign 417 the software application to an optimal subset of cores (in real-time) and instruct the scheduler 422 to schedule the software application to execute on the optimal subset of cores. In this example of the instant solution, a software application 429 is scheduled on cores #9 and #10 based on a combination of the current processing load of the multi-core processor 424 and runtime attributes of the software application 429 with respect to all of the cores on the multi-core processor 424.

Meanwhile, FIG. 4C illustrates a process 400C of generating weights 430 for determining the optimal subset of cores of the multi-core processor 424 for processing the software application. Referring to FIG. 4C, the optimizer 412 may receive weighting attributes from a developer, an administrator, or the like, via a graphical user interface (GUI) 418. For example, the GUI 418 may be output while registering or deploying a software application with the server host 420. In this example of the instant solution, a user may specifically set the weighting values including a weighting value 432 for runtime attributes of the software application and a weighting value 434 for the current processing load of the plurality of processing cores of the multi-core processor 424. Here, the GUI 418 may include input fields that enable the user to input a particular weighted value, percentage, ratio, etc. to define how each of the two variables are to be treated by the optimizer 412 when deciding the optimal subset of processing cores for processing a software application.

As another example of the instant solution, the optimizer 412 may receive runtime attributes of the software application from the runtime attribute database 415 (e.g., which may correspond to the runtime attribute database 315 in FIG. 3C, the runtime database 216 in FIG. 2D, or the like) and receive the current processing loads of each of the cores of the multi-core processor 424 from the load statistics database 426, via the load manager 414. In this example of the instant solution, the optimizer 412 may dynamically determine in real time or near real time the weighting value 432 and the weighting value 434 based on runtime attributes and/or current processing loads. As an example of the instant solution, the optimizer 412 may determine in real time or near real time to apply a greater weight to the weighting value 432 of the runtime attributes than the weighting value 434 of the current processing load when the current processing load is below its normal average, below a predetermined threshold, or the like.

As another example of the instant solution, the optimizer 412 may determine in real time or near real time to apply less weight to the weighting value 432 of the runtime attributes in comparison to the weighting value 434 of the current processing load when the current processing load is above a predetermined threshold, above an average, or the like. Furthermore, the optimizer 412 may execute an AI model 440 on the runtime attributes and the current processing load data to determine in real time or near real time an optimal core or subset of cores. Here, the AI model 440 may be trained to identify an optimal processor core or subset of cores based on historical processing data of the multi-core processor 424 including historical load data, application performances, etc. In response, the optimizer 412 may generate the dynamic assignment 417 which includes the optimal subset of cores determined by the AI model 440.

The instant solution is designed to optimize the assignment of processing cores for software execution, particularly when dealing with multi-core processors. The instant solution includes a memory and a processor, which is communicably coupled to the memory. The processor is configured to execute an optimization module on an optimizer host. The optimization module is responsible for assigning a software application to at least one core from a plurality of cores on a server host. Initially, the optimizer host, utilizing the optimization module, assigns the software application to a specific core or set of cores on the server host. This assignment is based on predefined parameters or initial assessments. The optimizer host then instructs the server host to process the software application using the assigned core(s). As the software application runs on the assigned core(s), the optimizer host collects runtime attributes, including performance metrics such as processing time, throughput, efficiency statistics, and current processing load, which are fed back from the server host. The optimization module analyzes the runtime attributes to determine the performance of the software application on the assigned core(s). Based on this analysis, the optimization module dynamically re-assigns the software application to different cores to enhance performance by selecting cores that are more suited to handle the software application's current workload.

The optimizer host re-instructs the server host to execute the software application on the newly assigned core(s) without interrupting the application's operation, allowing the software application to migrate to a different core or set of cores without restarting, thereby maintaining continuity and minimizing downtime. The optimizer host communicates with the server host over a computer network, which may be a local network or an internet connection. The communication is established prior to processing the software application, allowing for efficient data exchange and control commands. Additionally, the optimization module can instruct the server host to simulate the software application's execution on various cores. This simulation provides valuable data on how each core handles the application, contributing to the overall performance assessment and aiding in making more informed reassignment decisions.

The instant solution is configured to execute an optimization module on an optimizer host, which plays a central role in managing core assignments for software applications on a server host. The instant solution instructs the server host to simulate the execution of the software application on each of the plurality of cores to determine the performance characteristics of each core with respect to the software application. During the simulation, the server host executes the software application on various cores, and detailed performance metrics, also referred to as runtime attributes, are collected. The attributes include processing time, throughput, efficiency, and other relevant performance statistics. The optimizer host captures and analyzes the simulation statistics fed back from the server host. By examining the statistics, the optimization module can determine the relative performance of each core when executing the software application. The analysis helps in identifying which cores are most efficient and effective in handling the specific tasks of the software application.

Based on the performance determined from the simulation statistics, the optimization module dynamically re-assigns the software application to the most suitable core or set of cores. The reassignment is based on the comparative performance of the cores, ensuring that the software application is executed on the cores that offer optimal performance. The optimizer host then re-instructs the server host to execute the software application on these newly assigned cores. The dynamic reassignment process is iterative and continuous, allowing the solution to adapt to changing conditions and workloads. The ability to simulate execution and analyze performance data enables the optimization module to make informed decisions about core assignments, ultimately leading to enhanced performance and efficiency of the software application on the multi-core processor.

The instant solution is configured to execute an optimization module on an optimizer host. The function of this optimization module is to manage and optimize core assignments for software applications running on a server host. The optimizer host instructs the server host to simulate the execution of the software application across a plurality of cores. During the simulation phase, each core executes the software application, and detailed performance metrics, known as runtime attributes, are collected, including processing time, throughput, efficiency statistics, and other relevant performance data. The simulation statistics fed back from the server host provide a comprehensive view of how well each core performs when executing the software application. The optimization module captures these statistics and analyzes them to determine the relative performance of each core and identify which cores are most efficient and effective for running the software application.

The solution uses the performance data obtained from the simulation statistics to dynamically re-assign the software application to the most suitable core or set of cores. The reassignment process selects the core(s) that demonstrate the highest efficiency and performance metrics during the simulation. The optimization module monitors the performance of the software application on the assigned cores and makes further adjustments when optimizations are identified.

The instant solution is configured to optimize the assignment of processing cores for software execution in a multi-core processor environment. The solution executes an optimization module on an optimizer host, which is responsible for managing core assignments for software applications running on a server host. A channel of communication is established between the optimizer host and the server host over a computer network prior to instructing the server host to process the software application. This communication channel transfers instructions and data between the optimizer host and the server host. Once the communication channel is established, the optimizer host can instruct the server host to execute the software application on a specific core or set of cores. As the software application runs, the server host collects runtime attributes, such as processing time, throughput, efficiency statistics, and current processing load, and sends this data back to the optimizer host through the established communication channel.

The optimization module on the optimizer host analyzes the received runtime attributes to determine the software application's performance on the assigned core(s) and, based on this analysis, dynamically reassigns the software application to different cores to enhance performance. The optimizer host sends these reassignment instructions to the server host via the communication channel, ensuring that the software application is executed on the most suitable cores.

The instant solution is configured to move a software application from one core to another without restarting the application. This transition is crucial for maintaining the continuity and efficiency of the software application during dynamic reassignment processes. Initially, the optimizer host assigns the software application to a specific core or set of cores on the server host. This assignment is based on predefined parameters or initial assessments. As the software application runs, the optimizer host collects runtime attributes from the server host. These attributes include performance metrics, such as processing time, throughput, efficiency statistics, and current processing load. The optimization module analyzes these runtime attributes to determine the performance of the software application on the assigned core(s).

When the optimization module identifies that a different core or set of cores may provide increased performance for the software application, it dynamically reassigns the application to the new core(s). To ensure a seamless transition, the optimizer host transmits an instruction to the server host to move the software application from the current core(s) to the new core(s) without restarting the application. This instruction is sent over an established communication channel between the optimizer host and the server host, which ensures efficient data transfer and control commands. The server host, upon receiving the instruction, manages the transition of the software application from the old core(s) to the new core(s) in a seamless manner. This involves temporarily running the application on both the old and new cores to ensure there is no disruption in service. Once the application is fully operational on the new core(s), it stops execution on the old core(s).

The instant solution is configured to dynamically re-assign a software application to a core among the plurality of cores of the server host based on the processing load of the cores. The optimization process involves monitoring the performance of the software application and the current load on each core. The optimizer host assigns the software application to a specific core or set of cores on the server host based on predefined parameters or initial assessments. The optimizer host then instructs the server host to process the software application using the assigned core(s). As the software application runs, the server host collects runtime attributes, including performance metrics, such as processing time, throughput, efficiency statistics, and current processing load, and sends this data back to the optimizer host. The optimization module on the optimizer host analyzes these runtime attributes to determine the performance of the software application on the assigned core(s). When the analysis reveals that the current core(s) have a higher processing load that negatively impacts the performance of the software application, the optimization module dynamically reassigns the software application to a different core or set of cores with a lower processing load. The optimizer host transmits an instruction to the server host to reassign the software application to the newly identified core(s). The instruction ensures that the software application is moved to cores that have a lower processing load, thereby improving the application's performance and efficiency. The optimizer host monitors the performance and load of the cores, ensuring that the software application is running on the most optimal cores.

The instant solution is configured to dynamically pin future executions of a software application to specific cores based on real-time performance data and runtime attributes. This dynamic pinning process ensures that the software application consistently runs on the optimal cores for enhanced performance. The optimizer host initially assigns the software application to a specific core or set of cores on the server host based on initial assessments or predefined parameters. As the software application runs, the optimizer host collects runtime attributes from the server host, such as processing time, throughput, efficiency statistics, and current processing load. These attributes provide insights into the performance of the software application on the assigned cores. The optimization module analyzes the collected runtime attributes to determine the performance of the software application on the assigned cores. Based on the analysis, the optimization module identifies the optimal core or set of cores for executing the software application. This process involves evaluating the performance metrics to select cores that demonstrate the highest efficiency and effectiveness in handling the software application.

Once the optimal cores are identified, the optimizer host dynamically pins future executions of the software application to these cores. Dynamic pinning ensures that when the software application is executed, it runs on the cores that have been determined to provide optimal performance. The optimizer host transmits instructions to the server host to pin the software application to the identified cores for future executions. The dynamic pinning process is adaptive and iterative, allowing the solution to refine core assignments based on ongoing performance data. As the software application runs and conditions change, the optimizer host can update the pinned cores to reflect the most current performance assessments, ensuring that the software application runs on the optimal cores.

In one example, the instant solution optimizes core assignments for software applications in a multi-core processor environment. In a cloud computing environment, where multiple virtual machines (VMs) and containers are deployed across a distributed network of servers, the solution is employed to optimize the assignment of processing cores to software applications running within these VMs and containers. The optimizer host operates as a central control node, monitoring the performance of each application across various cores in the cloud infrastructure. The optimizer host uses machine learning algorithms to predict the performance of software applications based on historical runtime attributes and current workload data. The solution dynamically reallocates applications to different cores within a single server and also across multiple servers in the cloud network to balance the load and increase overall system performance. The optimizer communicates with different types of hypervisors and container orchestration platforms to ensure seamless integration and optimal resource utilization.

In another example, the instant solution optimizes the assignment of processing cores to software applications running on edge of the network devices (such as internet of things (IoT) devices, gateways, and local servers). The optimizer host is embedded within a local network controller that communicates with various edge devices. The optimizer host can operate in environments with limited connectivity, using locally cached performance data and runtime attributes to make optimization decisions. It supports heterogeneous computing environments, where edge devices may have different types of processors and varying core configurations. The solution prioritizes low-latency tasks and real-time processing requirements, dynamically reassigning cores to meet the stringent performance demands of edge applications, ensuring that edge computing applications, such as real-time analytics, video processing, and IoT data aggregation, are executed efficiently, with optimal use of local processing resources, reducing constant cloud communication and improving response times.

In another example, the instant solution optimizes the assignment of processing cores in high-performance computing (HPC) cluster environments. The optimizer host is integrated into the HPC cluster management software, coordinating the execution of jobs across the cluster's multi-core processors. The optimizer host leverages advanced scheduling algorithms to allocate tasks to cores based on their specific computational requirements and the current state of the cluster. It supports multi-threaded applications and can dynamically adjust the core assignments for individual threads within a single application, optimizing parallel processing performance. The solution includes mechanisms for stress testing and benchmarking cores, using the collected data to refine future core assignments and increase prediction accuracy.

The instant solution optimizes the execution of software applications on multi-core processors. The solution includes a memory and a processor communicably coupled to the memory, where the processor is configured to carry out specific tasks to enhance the performance and efficiency of software applications running on a server host. The processor executes a software application across a plurality of cores within the server host. During the execution, the software application is tested across these multiple cores to gather runtime attributes, including metrics such as processing time, throughput, current processing load, and efficiency statistics, which are used in understanding the performance characteristics of the software application on different cores. The processor, via an optimization module known as the optimizer, analyzes the captured runtime attributes to determine the optimal subset of cores for executing the software application. The optimizer uses these attributes to identify which cores provide optimal performance for specific tasks associated with the software application. This determination is made regardless of the current processing load of the cores, focusing instead on the intrinsic performance characteristics of each core.

Once the optimal subset of cores is identified, the processor dynamically assigns the software application to these optimal cores. The dynamic assignment involves reconfiguring the server host to ensure that the software application runs on the identified optimal cores, thereby improving its overall performance. The dynamic assignment process can seamlessly migrate the software application from one set of cores to another without requiring a restart, ensuring continuous operation and minimal disruption. The processor modifies the server host to execute the software application on the optimal subset of cores. This modification ensures that future executions of the software application are pinned to these cores, maintaining the enhanced performance achieved through the optimization process. The solution iteratively repeats this process, continuously refining the core assignments based on real-time performance data to adapt to changing workloads and application requirements.

The instant solution is configured to capture and utilize runtime attributes, including fluctuations in processing load, to identify the optimal subset of cores for execution. The processor executes the software application across a plurality of cores within the server host. During the execution phase, the software application is subjected to various tests to simulate different types of workloads and operational conditions. These tests are designed to collect detailed runtime attributes, which include metrics such as processing time, throughput, current processing load, and efficiency statistics. These tests also capture fluctuations in the processing load created by the software application on each of the cores. The fluctuations in processing load provide insights into how the software application performs under varying conditions and how each core handles different types of computational stress. By analyzing these fluctuations, the processor can identify patterns and behaviors that are not apparent from static performance metrics alone.

Using these captured runtime attributes, including the fluctuations in processing load, the processor employs an optimizer module to determine the optimal subset of cores for executing the software application. The optimizer module analyzes the performance data to identify which cores offer the optimal combination of efficiency and stability under varying load conditions. This analysis ensures that the software application is assigned to the cores that can handle its workload most effectively, even when the processing demands fluctuate. Once the optimal subset of cores is identified, the processor dynamically assigns the software application to these cores. The assignment process involves reconfiguring the server host to ensure that the software application is executed on the identified optimal cores. The dynamic assignment process is designed to be seamless, allowing the software application to migrate from one set of cores to another without interruption, thus maintaining continuous operation and optimal performance. The processor is further configured to modify any default assignments of the software application among the cores based on the identified optimal subset. This modification process ensures that the software application benefits from improved runtime attributes by running on the most suitable cores.

The instant solution is configured to capture and utilize detailed performance data to dynamically assign software applications to the most suitable cores. The processor executes the software application across multiple cores within the server host. During this phase, the software application undergoes rigorous testing on these cores to collect runtime attributes. The attributes include various performance metrics such as processing time, throughput, current processing load, and efficiency statistics. The testing is designed to simulate different types of workloads and operational conditions, ensuring comprehensive data collection. The processor captures the runtime attributes to understand how the software application performs on each core under various conditions. With this detailed performance data, the processor employs an optimization module to analyze and determine the optimal subset of cores for executing the software application. The optimizer identifies the cores that provide optimal performance and efficiency based on the captured runtime attributes, regardless of the current processing load.

Once the optimal subset of cores is identified, the processor dynamically assigns the software application to the cores. The dynamic assignment involves reconfiguring the server host to ensure that the software application runs on the identified optimal cores. The assignment process is seamless, allowing the software application to migrate from the default assigned cores to the optimal subset without requiring a restart, thus ensuring continuous operation. The processor is also configured to modify the default assignment of the software application among the plurality of cores. The modification process is based on the analysis of the runtime attributes and is aimed at improving the runtime performance of the software application. By modifying the default core assignment, the solution ensures that the software application benefits from enhanced performance and efficiency provided by the optimal subset of cores.

The instant solution is configured to determine and utilize detailed performance metrics to enhance software execution. The processor executes a software application across a plurality of cores within the server host, gathering runtime attributes. The optimizer module within the processor analyzes the captured runtime attributes to determine the optimal subset of cores for executing the software application. The analysis involves comparing the performance of the software application on each core and identifying the cores that provide optimal performance and efficiency. The optimizer focuses on the intrinsic performance characteristics of each core rather than just the current processing load. Once the optimal subset of cores is identified, the processor dynamically assigns the software application to these optimal cores. This dynamic assignment involves reconfiguring the server host to ensure that the software application runs on the identified optimal cores, allowing the software application to migrate from the initially assigned cores to the optimal subset without interruption. The processor is further configured to determine that assignments of other subsets of cores to the software application do not improve its runtime attributes by monitoring and analyzing the performance of the software application on the assigned cores. The optimizer ensures that the software application remains assigned to the optimal subset of cores unless it is conclusively determined that a different subset may not enhance performance.

The instant solution is configured to optimize the performance of software applications on multi-core processors by dynamically assigning the applications to the most efficient cores based on detailed runtime attributes. The processor executes the software application across multiple cores within the server host. During this phase, the software application undergoes rigorous testing on these cores to collect runtime attributes. These attributes include various performance metrics such as processing time, throughput, current processing load, and efficiency statistics. With this detailed performance data, the processor employs an optimization module to analyze and determine the optimal subset of cores for executing the software application. The optimizer identifies the cores that provide optimal performance and efficiency based on the captured runtime attributes, regardless of the current processing load. Once the optimal subset of cores is identified, the processor dynamically assigns the software application to these cores by reconfiguring the server host to ensure that the software application runs on the identified optimal cores. The processor is configured to pin the threads of the software application to the identified optimal subset of cores for future executions. Pinning threads ensures that the specific threads of the software application are consistently executed on the same subset of cores, leveraging the previously determined optimal core assignments. This pinning process ensures that the software application maintains its enhanced performance and efficiency during future executions, as the pinned cores are already known to provide an optimal execution environment based on the detailed runtime attributes.

The instant solution is configured to optimize the execution of software applications on multi-core processors by dynamically assigning them to the most efficient cores based on detailed runtime attributes. The processor executes a software application across multiple cores within the server host, gathering comprehensive runtime attributes, including processing time, throughput, current processing load, and efficiency statistics. The processor captures these runtime attributes and uses them to identify the optimal subset of cores for executing the software application. The processor is further configured to capture additional runtime attributes of the software application as it continues to execute on the optimal subset of cores. This continuous monitoring allows the processor to gather new performance data, which it analyzes to determine when an updated optimal subset of cores is expected. When the analysis indicates that a different subset of cores may now provide increased performance, the processor dynamically modifies the core assignments to execute the software application on this updated optimal subset.

The instant solution is configured to determine the optimal subset of cores based on a thread count initially assigned to the software application. The processor executes a software application across a plurality of cores within the server host. During the execution phase, the software application undergoes rigorous testing across these cores to collect runtime attributes. These attributes include various performance metrics such as processing time, throughput, current processing load, and efficiency statistics, which are used in understanding the performance characteristics of the software application on different cores under various conditions. The processor employs an optimization module to analyze and determine the optimal subset of cores for executing the software application. Once the optimal subset of cores is identified, the processor dynamically assigns the software application to these optimal cores. The processor determines the optimal subset of cores based on the thread count initially assigned to the software application. This determination involves analyzing the number of threads that the software application is expected to execute and matching this thread count to the available cores. By considering the thread count, the processor ensures that the software application is assigned to a subset of cores that can handle its threading requirements efficiently, thus optimizing both parallel processing and overall execution performance.

In one example, the instant solution optimizes the performance of web server applications in a data center environment. The solution includes a server host with a multi-core processor, running multiple web applications, and an optimizer host that oversees the dynamic allocation of processing cores. Upon receiving a new web application deployment request, the optimizer initiates a testing phase where it runs the application on different cores to collect runtime attributes like response time, request handling capacity, and processing efficiency. The data is stored in a runtime attributes database. The optimizer analyzes the data, factoring in current core loads and applying weights to prioritize performance attributes above any load balancing attributes. The optimizer assigns the application to the subset of cores that provide the optimal performance based on these criteria. As the web application runs, the optimizer continuously gathers performance data, allowing it to dynamically reassign cores in real time to adapt to changing loads and application demands.

In another example, the instant solution optimizes the streaming of high-definition videos in a multimedia content delivery network (CDN). The solution includes CDN edge servers with multi-core processors distributed across various geographic locations and a centralized optimizer host. The optimizer host runs an optimization module that evaluates the performance of video streaming tasks across different cores of the edge servers. When a new video streaming session is initiated, the optimizer assigns it to default cores and begins capturing runtime attributes such as buffering time, frame rate stability, and bandwidth usage. The data is analyzed in real-time to dynamically reassign the streaming tasks to the optimal cores, ensuring high-quality playback and minimal buffering for users. Continuously monitoring and adjusting the core assignments based on real-time performance metrics, the CDN can deliver a seamless viewing experience to a large number of users, even during peak times, while efficiently managing network resources.

In another example, the instant solution is configured for a financial trading platform that requires ultra-low latency and high throughput for transaction processing. The solution includes a trading server host with a multi-core processor and an external optimizer host designed to handle high-frequency trading (HFT) applications. The optimizer host runs a sophisticated optimization module that tests the trading algorithms on various cores, capturing detailed runtime attributes such as transaction latency, processing speed, and core utilization efficiency. The optimizer assigns the trading algorithms to the initial cores based on this data. During live trading, the optimizer continuously monitors the runtime attributes and dynamically reallocates the trading algorithms to ensure the lowest possible latency and highest transaction throughput. The real-time adjustment capability allows the trading platform to maintain optimal performance, adapt to market fluctuations, and execute trades faster than competitors, providing a significant advantage in the high-stakes financial trading environment.

The instant solution is designed to optimize the execution of software applications on multi-core processors by dynamically assigning and re-assigning processing cores based on runtime attributes and current processing loads. The solution comprises a memory and a processor that is communicably coupled to the memory. The processor is configured to execute a software application on a plurality of different cores, identify runtime attributes of these cores during the execution of the software application, and identify the current processing loads of the cores. By adding a weight to the runtime attributes of the cores, the processor generates weighted runtime attributes. Based on these weighted runtime attributes and the current processing loads, the processor assigns the software application to a subset of cores and updates the execution of the software application to use this subset of cores. The multi-core processor is part of a server host, and the optimization is managed by an optimizer host. The optimizer host runs an optimization module that communicates with the server host through a network channel. The server host includes a scheduler and an operating system that manages the allocation and scheduling of tasks across the processor cores. When the software application is initially executed, it may be assigned to a default set of cores based on pre-configured parameters or developer settings. The runtime attributes, such as processing time, throughput, and efficiency statistics, are captured and fed back to the optimizer host. The optimizer host includes a load manager that collects these runtime attributes and stores them in a runtime attributes database.

The optimizer module analyzes the runtime attributes to determine an optimal subset of cores for executing the software application. The analysis may involve running tests on different cores to gather performance data and identify which cores perform specific tasks most efficiently. The dynamic assignment process involves the optimizer module generating a dynamic assignment instruction that is sent to the scheduler. This instruction specifies which cores are to be used to execute the software application based on the analysis of the weighted runtime attributes and current processing loads. The scheduler then re-assigns the software application to the identified subset of cores, ensuring that the execution is updated to reflect this new assignment.

The instant solution is configured to execute a software application on a plurality of different cores, identify runtime attributes of these cores while executing the software application, and add a first weight to the runtime attributes and a second weight to the current processing loads, wherein the first weight is greater in value than the second weight. When the software application is executed, it is assigned to a default set of cores. The runtime attributes of the cores, such as processing time, throughput, and efficiency statistics, are captured and fed back to the optimizer host. This data is collected by a load manager running on the optimizer host and stored in a runtime attributes database. The optimizer module on the optimizer host is responsible for analyzing the runtime attributes and the current processing loads of the cores to determine the optimal subset of cores for executing the software application. The optimizer applies different weights to the runtime attributes and the current processing loads. The first weight, applied to the runtime attributes, is greater than the second weight, applied to the current processing loads. This weighting scheme prioritizes the performance characteristics of the cores as indicated by the runtime attributes over their current load. For instance, the runtime attributes might include metrics like the time taken to finish specific tasks, throughput, and other performance indicators. These attributes are given a higher priority because they directly reflect how efficiently a core can execute the software application. The current processing loads, which indicate how much computational work the cores are handling at any given moment, are considered but given less importance because they can fluctuate and may not represent the long-term performance of the cores. When the optimizer receives runtime data and current load statistics, it calculates weighted runtime attributes for each core. This involves multiplying the runtime attributes by the first weight and the current processing loads by the second weight. The cores with the highest weighted runtime attributes are considered the most optimal for executing the software application. Once the optimal cores are identified, the optimizer generates a dynamic assignment instruction that is sent to the scheduler on the server host. This instruction specifies which cores are to be used to execute the software application based on the analysis. The scheduler then re-assigns the software application to these identified cores, ensuring that the execution is updated accordingly.

The instant solution is configured to assign a software application to a first processing core that has a greater processing load than a second processing core to which the software application is not assigned. The software application may be assigned to a default set of cores based on predefined parameters or developer settings when it is executed. The runtime attributes of these cores, such as processing time, throughput, and efficiency metrics, are continuously monitored and captured. The optimizer module on the optimizer host analyzes the runtime attributes and current processing loads of the cores to determine the optimal core or subset of cores for executing the software application. The optimizer can assign the software application to a processing core with a higher processing load when the runtime attributes of that core indicate increased performance for the specific tasks of the software application. For instance, the optimizer might detect that a particular core, despite having a higher processing load, demonstrates increased efficiency and faster processing times for tasks similar to those expected by the software application. This core might have specialized capabilities or optimizations that make it more suitable for the software application's workload, even when it is currently handling more tasks compared to other cores. The optimizer achieves this by evaluating the runtime attributes, such as the time taken to finish specific tasks, throughput rates, and other performance indicators. These attributes are compared across all cores, and the optimizer identifies which core or cores can execute the software application most efficiently. This decision is made by weighing the runtime attributes more heavily than the current processing load, allowing the optimizer to prioritize performance characteristics over current utilization.

Once the optimal core is identified, the optimizer generates a dynamic assignment instruction that specifies this core for executing the software application. This instruction is sent to the scheduler on the server host, which re-assigns the software application to the identified core.

The instant solution is configured to assign a software application to a first processing core that has a greater utilization than a second processing core to which the software application is not assigned. The software application is initially assigned to a default set of cores based on predefined parameters or developer settings. The optimizer module on the optimizer host is responsible for analyzing the current utilization of the cores to determine the optimal core or subset of cores for executing the software application. In some cases, a core with higher utilization might be more suited for the software application due to its superior performance metrics. For example, the optimizer might find that a particular core, despite having higher utilization, performs the expected tasks more efficiently than a less utilized core. Once the optimal core is identified, the optimizer generates a dynamic assignment instruction that specifies this core for executing the software application. The instruction is sent to the scheduler on the server host, which re-assigns the software application to the identified core.

The instant solution is configured to dynamically re-assign a second software application executing on the subset of cores to a different subset of cores and update the second software application to execute on the different subset of cores. The optimizer module on the optimizer host is responsible for analyzing the runtime attributes and the current processing loads of the cores to determine the optimal core or subset of cores for executing each software application. The optimizer can dynamically re-assign cores based on real-time data, ensuring that each software application runs on the most suitable cores. When the optimizer identifies that a second software application is currently running on a subset of cores but detects that moving the second application to a different subset of cores may increase overall system performance, it can initiate the re-assignment. The optimizer generates a dynamic re-assignment instruction that specifies the new subset of cores for executing the second software application. The instruction is sent to the scheduler on the server host, which manages the transition.

The instant solution is configured to receive an input defining a predefined weight via a GUI and add the predefined weight to the runtime attributes. The optimizer module on the optimizer host analyzes the runtime attributes and current processing loads of the cores to determine the optimal core or subset of cores for executing the software application. The optimizer can receive user-defined weights through a GUI, allowing customization of the core assignment process based on specific performance priorities. The GUI serves as an interface for administrators or developers to input predefined weights. These weights adjust the significance of different runtime attributes when determining the optimal cores for executing a software application. For instance, a user might prioritize processing speed over the current load or vice versa. Upon receiving the input from the GUI, the optimizer incorporates the predefined weights into its analysis. The weights are added to the runtime attributes, effectively modifying the criteria used to select the optimal cores. For example, an administrator might use the GUI to set a higher weight on processing speed, indicating that the optimizer is to prioritize cores with the optimal performance metrics, even when they are currently heavily loaded. The optimizer then updates its core assignment strategy based on these weighted attributes, ensuring that the software application runs on the most suitable cores according to the user-defined priorities. The process involves the optimizer generating a dynamic assignment instruction that specifies the optimal cores for executing the software application based on the weighted runtime attributes. The instruction is sent to the scheduler on the server host, which re-assigns the software application to the identified cores.

The instant solution is configured to determine a dynamic weight based on the runtime attributes of the plurality of different cores and their current processing loads and add the dynamic weight to the runtime attributes. The optimizer module on the optimizer host analyzes the runtime attributes and current processing loads of the cores to determine the optimal core or subset of cores for executing the software application. A key aspect of this process involves determining a dynamic weight, which is based on both the runtime attributes and the current processing loads of the cores. The optimizer monitors the performance characteristics and current utilization of each core. The dynamic weight is calculated by evaluating the importance of various runtime attributes relative to the current processing loads, allowing the optimizer to adjust the significance of different performance metrics in real time, ensuring that the core assignment process remains adaptive to changing conditions. The dynamic weight is added to the runtime attributes, effectively modifying the criteria used to select the optimal cores and ensuring that the core assignment process is responsive to real-time performance data and workload fluctuations, maintaining optimal execution of the software application. Once the dynamic weights are calculated and added to the runtime attributes, the optimizer generates a dynamic assignment instruction. The instruction specifies the optimal cores for executing the software application based on the weighted attributes. The instruction is sent to the scheduler on the server host, which re-assigns the software application to the identified cores.

In one example, the instant solution optimizes core assignments within the control systems of autonomous vehicles. Each autonomous vehicle serves as a server host equipped with a multi-core processor, a scheduler, and an operating system. These control systems are responsible for processing data from various sensors, running complex algorithms for navigation, obstacle detection, and decision-making in real-time. The optimizer host, which may be located on the vehicle or remotely, collects runtime attributes and current processing loads from the vehicle's cores. The optimizer dynamically assigns high priority tasks, such as sensor data processing and AI-driven decision-making, to the cores with the optimal performance metrics, ensuring that the autonomous vehicle can respond quickly and accurately to changing environmental conditions and potential hazards.

In one example of the instant solution, an optimizer is run on an optimizer host, which is a separate system dedicated to managing the optimization process. Concurrently, the software application is executed on the server host, which comprises a plurality of processor cores. The optimizer on the optimizer host is responsible for assigning the software application to at least one core from the plurality of cores available on the server host. This initial assignment is based on predefined criteria or initial estimates. The software application then runs on the assigned core, during which the system collects one or more runtime attributes. These attributes are performance metrics that provide insight into how well the software application is performing on the assigned core. Once collected, the runtime attributes are sent back to the optimizer on the optimizer host for analysis. Using this data, the optimizer reassigns the software application to at least one different core within the server host. This reassignment is based on the analysis of the collected runtime attributes, aiming to find a core that offers increased performance for the application. After reassignment, the software application is run again on the server host, now utilizing the newly assigned core(s). This iterative process ensures that the software application runs on the most suitable processor cores, continuously optimizing its performance based on real-time data collected during its execution.

In one example of the instant solution, the software application is assigned to run on one or more processor cores within the server host. The server host is equipped with a plurality of processor cores, each capable of executing portions of the software application. Concurrently, an optimizer is operated on a separate system known as the optimizer host. The optimizer's function is to manage and refine the assignment of the software application to the processor cores on the server host, aiming to increase performance. As the software application runs on the server host, it generates various performance metrics or runtime attributes, such as processing time, throughput, and efficiency. These runtime attributes are collected during the execution of the software application and are used in assessing performance. Once collected, these attributes are transmitted to the optimizer on the optimizer host for further analysis. The optimizer uses these runtime attributes to evaluate how well the application is performing on the currently assigned processor cores. The optimizer then determines whether the current assignment of processor cores is optimal. This involves a dynamic process where the optimizer may reassign the software application to different processor cores within the server host. For each new assignment, the software application runs on the newly assigned cores, and the optimizer collects additional runtime attributes. These attributes are again transmitted back to the optimizer for analysis. The optimizer compares the performance data from different core assignments to identify the most efficient configuration. This process of reassigning the software application and evaluating performance continues iteratively. The optimizer's goal is to find an assignment of processor cores that maximizes the performance of the software application. An assignment is considered optimal when no further reassignments result in improved runtime attributes, indicating that the current configuration provides an optimized performance assignment based on the collected data.

In one example of the instant solution, the software application is executed on various cores within the server host. During this initial execution, the system identifies runtime attributes, which include performance metrics such as processing time, throughput, and efficiency, that reflect how well the software is running on the server host. Simultaneously, the method involves identifying the current processing load of the application on the server host. This load data provides insights into the computational demands placed on each core by the software application. To enhance the analysis, a weight is added to the runtime attributes, creating weighted runtime attributes that prioritize certain performance metrics in assessing the software application's efficiency on different cores. Based on the combination of the weighted runtime attributes and the current processing loads, the software application is assigned to a subset of cores. This subset is selected from the plurality of cores available on the server host, ensuring that the chosen cores are optimal for running the application. Finally, the software application is executed to utilize the identified optimal subset of cores ensuring that the application runs efficiently, leveraging the chosen cores as determined by the weighted analysis of runtime attributes and current processing loads.

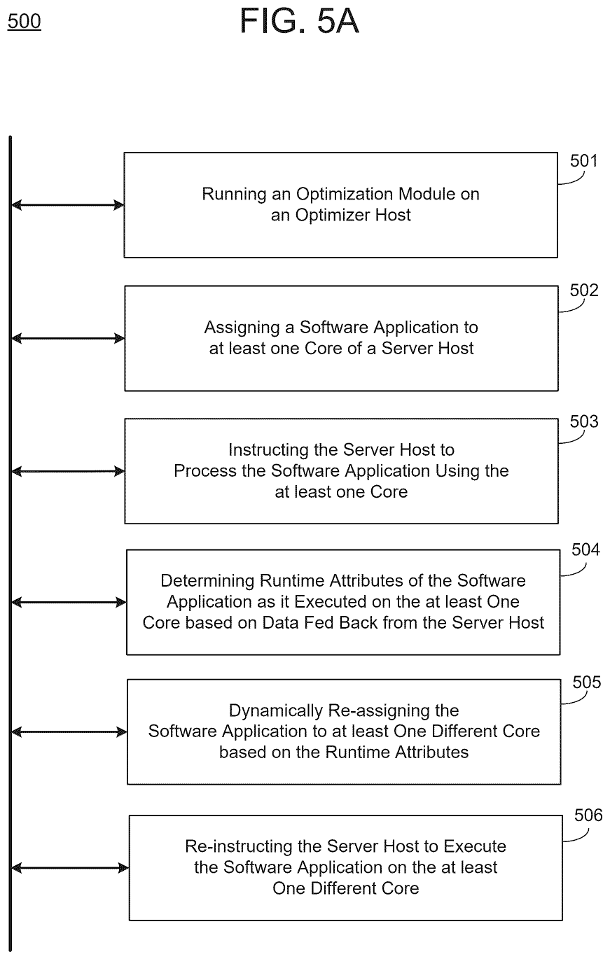

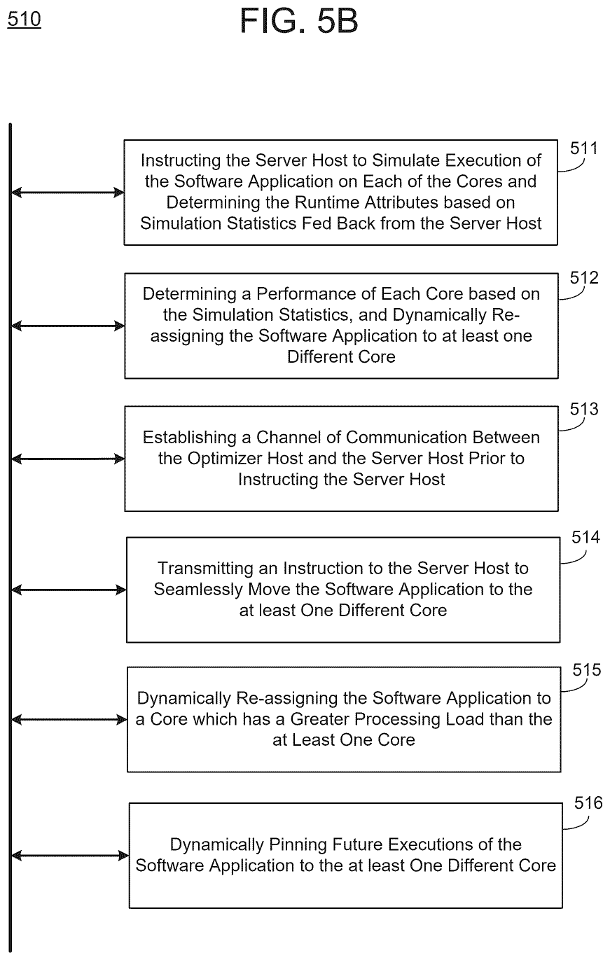

FIG. 5A illustrates a method 500 of dynamically re-assigning processing cores to a software application based on runtime attributes according to examples and features of the instant solution. For example, the method 500 may be performed by at least one processor. For example, the at least one processor may be of a host platform such as a cloud platform, a web server, a software application, a combination of servers and platforms, and the like. Referring to FIG. 5A, in 501, the method may include running an optimization module on an optimizer host. In 502, the method may include assigning, by the optimizer host, a software application to at least one core from among a plurality of cores of a server host.

In 503, the method may include instructing, by the optimizer host, the server host to process the software application using the at least one core assigned to the software application. In 504, the method may include determining, by the optimizer host, runtime attributes of the software application while it is executing on the at least one core based on data fed back from the server host. In 505, the method may include dynamically re-assigning, by the optimization module, the software application to at least one different core from among the plurality of cores of the server host based on the runtime attributes. In 506, the method may include re-instructing, by the optimizer host, the server host to execute the software application on the at least one different core instead of the at least one core.

FIG. 5B illustrates a method 510 of dynamically re-assigning processing cores to a software application based on runtime attributes according to examples and features of the instant solution. For example, the method 510 may be performed by at least one processor. For example, the at least one processor may be of a host platform such as a cloud platform, a web server, a software application, a combination of servers and platforms, and the like. Referring to FIG. 5B, in 511, the method may include instructing the server host to simulate execution of the software application on each of the plurality of cores and determining runtime attributes of each of the plurality of cores based on simulation statistics fed back from the server host.

In 512, the method may include determining a performance of each core from among the plurality of cores based on the simulation statistics, and dynamically re-assigning the software application to the at least one different core based on a respective performance of the at least one core from among the plurality of cores. In 513, the method may further include establishing a channel of communication between the optimizer host and the server host over a computer network, prior to instructing the server host to process the software application.

In 514, the method may include transmitting an instruction to the server host to seamlessly move the software application from the at least one core to the at least one different core without restarting the software application. In 515, the method may include dynamically re-assigning the software application to a core from among the plurality of cores of the server host which has a greater processing load than the at least one core. In 516, the method may include dynamically pinning future executions of the software application to the at least one different core of the server host.

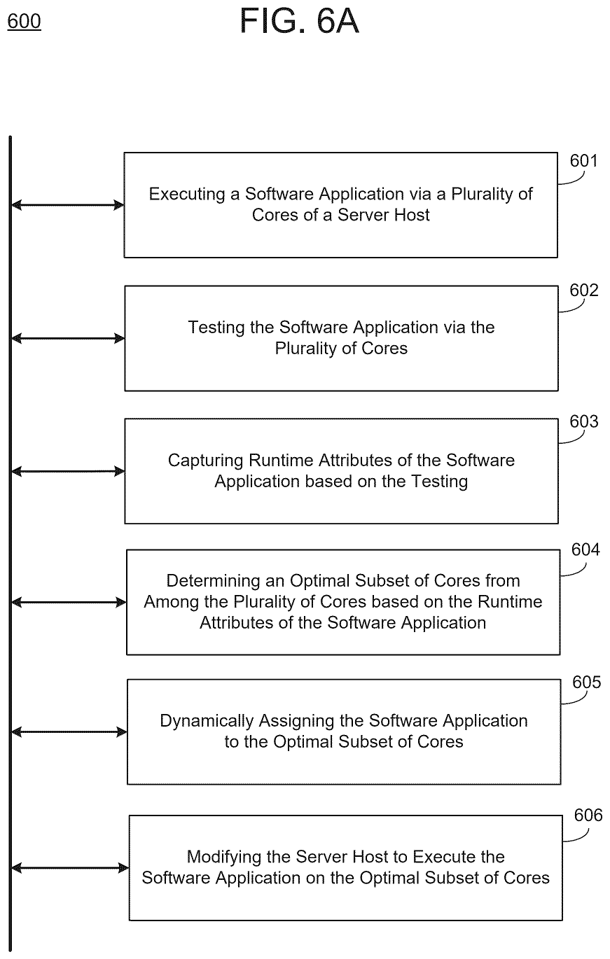

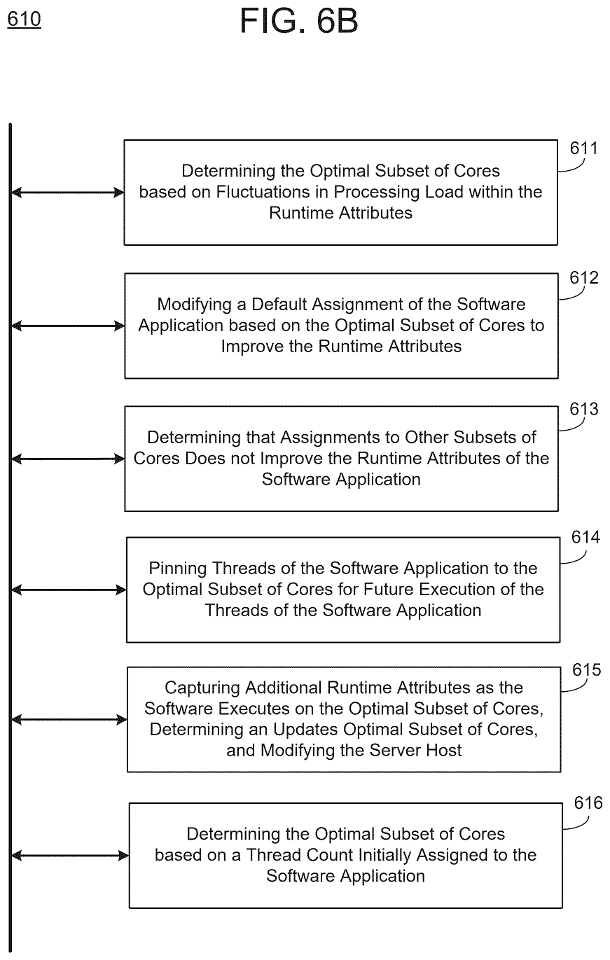

FIG. 6A illustrates a method 600 of stress testing processing cores and assigning a software application to an optimal subset of cores based on the stress testing according to examples and features of the instant solution. For example, the method 600 may be performed by at least one processor. For example, the at least one processor may be of a host platform such as a cloud platform, a web server, a software application, a combination of servers and platforms, and the like. Referring to FIG. 6A, in 601, the method may include executing a software application via a plurality of cores of a server host. In 602, the method may include testing the software application while executing the software application via the plurality of cores of the server host.

In 603, the method may include capturing runtime attributes of the software application based on the testing. In 604, the method may include determining, via an optimizer, an optimal subset of cores for executing the software application from among the plurality of cores of the server host based on the runtime attributes of the software application. In 605, the method may include dynamically assigning, via the optimizer, the software application to the optimal subset of cores. In 606, the method may include modifying the server host to execute the software application on the optimal subset of cores.

FIG. 6B illustrates a method 610 of stress testing processing cores and assigning a software application to an optimal subset of cores based on the stress testing according to examples and features of the instant solution. For example, the method 610 may be performed by at least one processor. For example, the at least one processor may be of a host platform such as a cloud platform, a web server, a software application, a combination of servers and platforms, and the like. Referring to FIG. 6B, in 611, the method may include capturing fluctuations in processing load created by the software application on each of the plurality of cores based on the testing, and determining the optimal subset of cores based on the fluctuations in the processing load created by the software application.

In 612, the method may include modifying a default assignment of the software application among the plurality of cores of the server host based on the optimal subset of cores to improve the runtime attributes of the software application at the server host. In 613, the method may include determining that assignments of other subsets of cores to the software application do not improve the runtime attributes of the software application. In 614, the method may include pinning threads of the software application to the optimal subset of cores for future executions of the threads of the software application.

In 615, the method may include capturing additional runtime attributes of the software application as it executes on the optimal subset of cores, determining an updated optimal subset or cores for executing the software application based on the additional runtime attributes, and dynamically modifying the server host to execute the software application on the updated optimal subset of cores. In 616, the method may include determining the optimal subset of cores based on a thread count initially assigned to the software application.

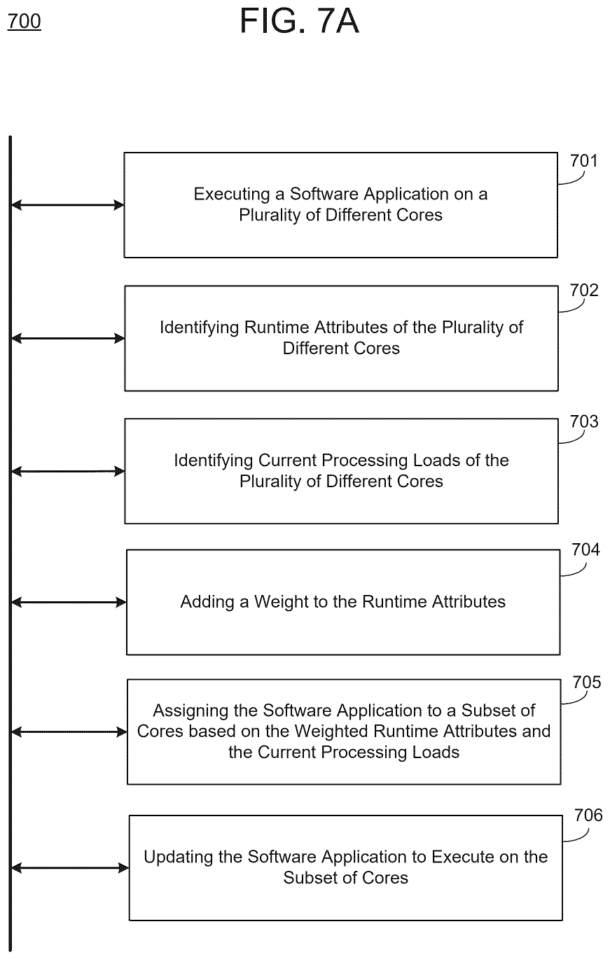

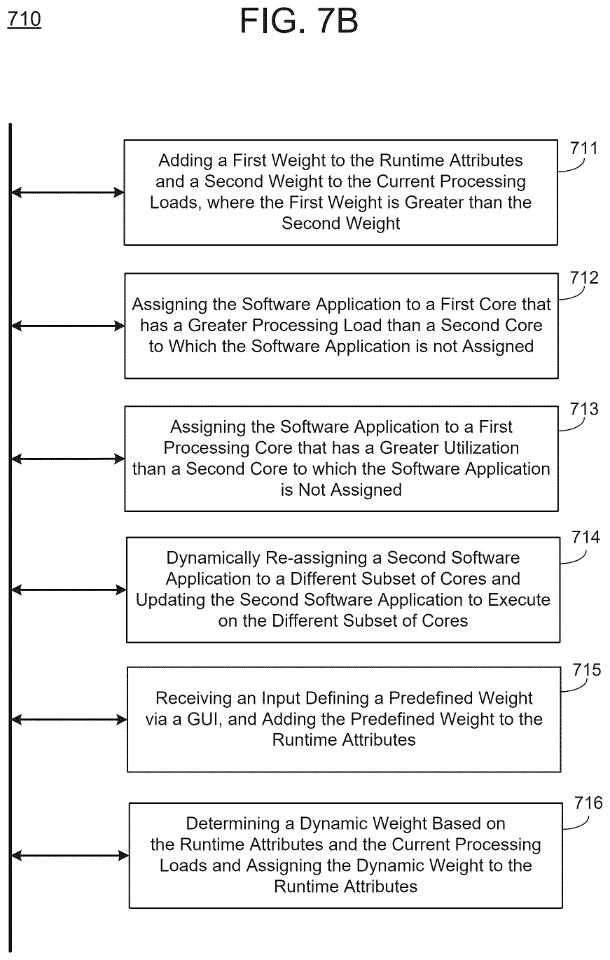

FIG. 7A illustrates a method 700 of weighting runtime attributes of a plurality of processing cores and assigning a software application to a subset of cores based on the weighted runtime attributes according to examples and features of the instant solution. For example, the method 700 may be performed by at least one processor. For example, the at least one processor may be of a host platform such as a cloud platform, a web server, a software application, a combination of servers and platforms, and the like. Referring to FIG. 7A, in 701, the method may include executing a software application on a plurality of different cores. In 702, the method may include identifying runtime attributes of the plurality of different cores while executing the software application.

In 703, the method may include identifying current processing loads of the plurality of different cores. In 704, the method may include adding a weight to the runtime attributes of the plurality of different cores to generate weighted runtime attributes. In 705, the method may include assigning the software application to a subset of cores from among the plurality of different cores based on the weighted runtime attributes and the current processing loads of the plurality of different cores. In 706, the method may include updating the executing of the software application to execute the software application via the subset of cores.

FIG. 7B illustrates a method 710 of weighting runtime attributes of a plurality of processing cores and assigning a software application to a subset of cores based on the weighted runtime attributes according to examples and features of the instant solution. For example, the method 710 may be performed by at least one processor. For example, the at least one processor may be of a host platform such as a cloud platform, a web server, a software application, a combination of servers and platforms, and the like. Referring to FIG. 7B, in 711, the method may include adding a first weight to the runtime attributes and a second weight to the current processing loads, wherein the first weight is greater in value than the second weight. In 712, the method may include assigning the software application to a first processing core that has a greater processing load than a second processing core to which the software application is not assigned.

In 713, the method may include assigning the software application to a first processing core that has a greater utilization than a second processing core to which the software application is not assigned. In 714, the method may include dynamically re-assigning a second software application executing on the subset of cores to a different subset of cores and updating the second software application to execute on the different subset of cores. In 715, the method may further include receiving an input defining a predefined weight via a graphical user interface (GUI), and the adding comprises adding the predefined weight to the runtime attributes. In 716, the method may further include determining a dynamic weight based on the runtime attributes of the plurality of different cores and the current processing loads of the plurality of different cores, wherein the adding comprise adding the dynamic weight to the runtime attributes.

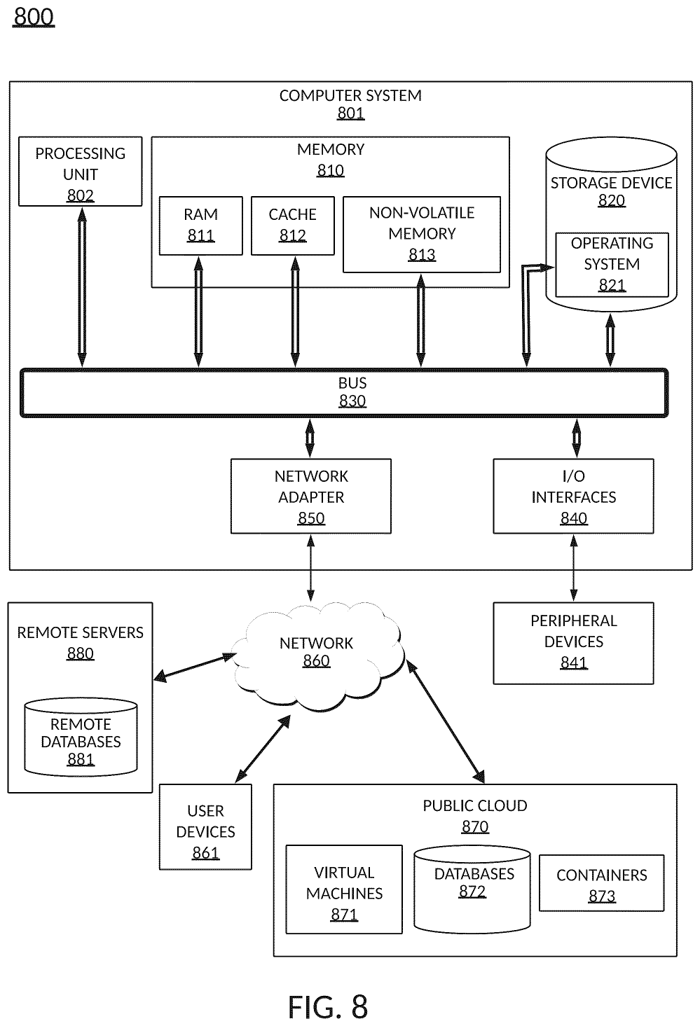

The examples and features of the instant solution may be implemented in one or more of the elements described or depicted herein, including for example, the elements described or depicted in FIG. 8. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 8 illustrates an example computer system architecture, which may represent or be integrated in any of the above-described components, etc.

FIG. 8 illustrates a computing environment according to the instant solution's example features, structures, or characteristics. FIG. 8 is not intended to suggest any limitation as to the scope of use or functionality of features, structures, or characteristics of the instant solution of the application described herein. Regardless, the computing environment 800 can be implemented to perform any of the functionalities described herein. In computing environment 800, there is a computer system 801, operational within numerous other general-purpose or special-purpose computing system environments or configurations.

Computer system 801 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 860 or querying a database. Depending upon the technology, the performance of a computer-implemented method may be distributed among multiple computers and among multiple locations. However, in this presentation of the computing environment 800, a detailed discussion is focused on a single computer, specifically computer system 801, to keep the presentation as simple as possible.

Computer system 801 may be located in a cloud, even though it is not shown in a cloud in FIG. 8. On the other hand, computer system 801 may not be in a cloud except to any extent as may be affirmatively indicated. Computer system 801 may be described in the general context of computer system-executable instructions, such as program modules, executed by a computer system 801. Generally, program modules may include routines, programs, objects, components, logic, data structures, and so on that perform tasks or implement certain abstract data types. As shown in FIG. 8, computer system 801 in computing environment 800 is shown in the form of a general-purpose computing device. The components of computer system 801 may include but are not limited to, at least one processor or processing unit 802, a system memory 810, and a bus 830 that couples various system components, including system memory 810 to processing unit 802.

Processing unit 802 includes at least one computer processor of any type now known or to be developed. The processing unit 802 may contain circuitry distributed over multiple integrated circuit chips. The processing unit 802 may also implement multiple processor threads and multiple processor cores. Cache 812 is a memory that may be in the processor chip package(s) or located “off-chip,” as depicted in FIG. 8. Cache 812 is typically used for data or code accessed by the threads or cores running on the processing unit 802. In some computing environments, processing unit 802 may be designed to work with qubits and perform quantum computing.

Memory 810 is any volatile memory now known or to be developed in the future. Examples include dynamic random-access memory (RAM) 811 or static type RAM 811. Typically, the volatile memory is characterized by random access, but this may not be the characterization unless affirmatively indicated. In computer system 801, memory 810 is in a single package. It is internal to computer system 801, but alternatively or additionally, the volatile memory may be distributed over multiple packages and/or located externally with respect to computer system 801. By way of example, memory 810 can be provided for reading from and writing to a non-removable, non-volatile magnetic media (shown as storage device 820, and typically called a “hard drive”). Memory 810 may include at least one program product having a set (e.g., at least one) of program modules configured to carry out the functions of various features, structures, or characteristics of the instant solution of the application. A typical computer system 801 may include cache 812, a specialized volatile memory generally faster than RAM 811 and generally located closer to the processing unit 802. Cache 812 stores frequently accessed data and instructions accessed by the processing unit 802 to speed up processing time. The computer system 801 may also include non-volatile memory 813 in the form of ROM, PROM, EEPROM, and flash memory. Non-volatile memory 813 often contains programming instructions for starting the computer, including the basic input/output system (BIOS) and information to start the operating system 821.

Computer system 801 may include a removable/non-removable, volatile/non-volatile computer storage device 820. For example, storage device 820 can be a non-removable, non-volatile magnetic media (not shown and typically called a “hard drive”). At least one data interface can connect it to the bus 830. In features, structures, or characteristics of the instant solution where computer system 801 has a large amount of storage (for example, where computer system 801 locally stores and manages a large database), then this storage may be provided by peripheral storage devices 820 designed for storing very large amounts of data, such as a storage area network (SAN) that is shared by multiple, geographically distributed computers.

The operating system 821 is software that manages computer system 801 hardware resources and provides common services for computer programs. Operating system 821 may take several forms, such as various known proprietary operating systems or open-source Portable Operating System Interface type operating systems that employ a kernel.

The bus 830 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 830 is the signal conduction path that allows the various components of computer system 801 to communicate.

Computer system 801 may communicate with at least one peripheral device, 841, via an input/output (I/O) interface, 840. Such devices may include a keyboard, a pointing device, a display, etc.; at least one device that enables a user to interact with computer system 801; and/or any devices (e.g., network card, modem, etc.) that enable computer system 801 to communicate with at least one other computing devices. Such communication can occur via I/O interface 840. As depicted, I/O interface 840 communicates with the other components of computer system 801 via bus 830.

Network adapter 850 enables the computer system 801 to connect and communicate with at least one network 860, such as a local area network (LAN), a wide area network (WAN), and/or a public network (e.g., the Internet). It bridges the computer's internal bus 830 and the external network, exchanging data efficiently and reliably. The network adapter 850 may include hardware, such as modems or Wi-Fi signal transceivers, and software for packetizing and/or de-packetizing data for communication network transmission. Network adapter 850 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 860 is any computer network that can receive and/or transmit data. Network 860 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 860 may be replaced and/or supplemented by LANs designed to communicate data between devices in a local area, such as a Wi-Fi network. The network 860 typically includes computer hardware such as copper transmission cables, optical transmission fibers, wireless transmission, routers, firewalls, switches, gateway computers, edge servers, and network infrastructure known now or to be developed in the future. Computer system 801 connects to network 860 via network adapter 850 and bus 830.

User devices 861 are any computer systems used and controlled by an end user in connection with computer system 801. For example, in a hypothetical case where computer system 801 is designed to provide a recommendation to an end user, this recommendation may typically be communicated from network adapter 850 of computer system 801 through network 860 to a user device 861, allowing user device 861 to display, or otherwise present, the recommendation to an end user. User devices can be a wide array, including personal computers, laptops, tablets, hand-held, mobile phones, etc.

A public cloud 870 is an on-demand availability of computer system resources, including data storage and computing power, without direct active management by the user. Public clouds 870 are often distributed, with data centers in multiple locations for availability and performance. Computing resources on public clouds 870 are shared across multiple tenants through virtual computing environments comprising virtual machines 871, databases 872, containers 873, and other resources. A container 873 is an isolated, lightweight software for running a software application on the host operating system 821. Containers 873 are built on top of the host operating system's kernel and contain software applications and some lightweight operating system APIs and services. In contrast, virtual machine 871 is a software layer with an operating system 821 and kernel. Virtual machines 871 are built on top of a hypervisor emulation layer designed to abstract a host computer's hardware from the operating software environment. Public clouds 870 generally offers databases 872, abstracting high-level database management activities. At least one element described or depicted in FIG. 8 can perform at least one of the actions, functionalities, or features described or depicted herein.

Remote servers 880 are any computers that serve at least some data and/or functionality over a network 860, for example, WAN, a virtual private network (VPN), a private cloud, or via the Internet to computer system 801. These networks 860 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 880 can also host remote databases 881, with the database located on one remote server 880 or distributed across multiple remote servers 880. Remote databases 881 are accessible from database client applications installed locally on the remote server 880, other remote servers 880, user devices 861, or computer system 801 across a network 860. An AI/ML model described or depicted here may reside fully or partially on any of the elements described or depicted in FIG. 8.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

1. An apparatus, comprising:
a memory; and
a processor communicably coupled to the memory, the processor configured to:
execute a software application on a plurality of different cores,
identify runtime attributes of the plurality of different cores while executing the software application,
identify current processing loads of the plurality of different cores,
add a weight to the runtime attributes of the plurality of different cores to generate weighted runtime attributes,
assign the software application to a subset of cores from among the plurality of different cores based on the weighted runtime attributes and the current processing loads of the plurality of different cores, and
update the executing of the software application to execute the software application via the subset of cores.

2. The apparatus of claim 1, wherein the processor is configured to add a first weight to the runtime attributes and add a second weight to the current processing loads, wherein the first weight is greater in value than the second weight.

3. The apparatus of claim 1, wherein the processor is configured to assign the software application to a first processing core that has a greater processing load than a second processing core to which the software application is not assigned.

4. The apparatus of claim 1, wherein the processor is configured to assign the software application to a first processing core that has a greater utilization than a second processing core to which the software application is not assigned.

5. The apparatus of claim 1, wherein the processor is configured to dynamically re-assign a second software application executing on the subset of cores to a different subset of cores and update the second software application to execute on the different subset of cores.

6. The apparatus of claim 1, wherein the processor is further configured to receive an input defining a predefined weight via a graphical user interface (GUI), and add the predefined weight to the runtime attributes.

7. The apparatus of claim 1, wherein the processor is further configured to determine a dynamic weight based on the runtime attributes of the plurality of different cores and the current processing loads of the plurality of different cores, and add the dynamic weight to the runtime attributes.

8. A method comprising:
executing a software application on a plurality of different cores;
identifying runtime attributes of the plurality of different cores while executing the software application;
identifying current processing loads of the plurality of different cores;
adding a weight to the runtime attributes of the plurality of different cores to generate weighted runtime attributes;
assigning the software application to a subset of cores from among the plurality of different cores based on the weighted runtime attributes and the current processing loads of the plurality of different cores; and
updating the executing of the software application to execute the software application via the subset of cores.

9. The method of claim 8, wherein the adding further comprises adding a first weight to the runtime attributes and a second weight to the current processing loads, wherein the first weight is greater in value than the second weight.

10. The method of claim 8, wherein the assigning comprises assigning the software application to a first processing core that has a greater processing load than a second processing core to which the software application is not assigned.

11. The method of claim 8, wherein the assigning comprises assigning the software application to a first processing core that has a greater utilization than a second processing core to which the software application is not assigned.

12. The method of claim 8, wherein the updating comprises dynamically re-assigning a second software application executing on the subset of cores to a different subset of cores and updating the second software application to execute on the different subset of cores.

13. The method of claim 8, further comprising receiving an input defining a predefined weight via a graphical user interface (GUI), and the adding comprises adding the predefined weight to the runtime attributes.

14. The method of claim 8, further comprising determining a dynamic weight based on the runtime attributes of the plurality of different cores and the current processing loads of the plurality of different cores, wherein the adding comprise adding the dynamic weight to the runtime attributes, wherein the determining the dynamic weight is based on at least one of a training of an artificial intelligence (AI) model or an executing of an AI model.

15. A computer-readable storage medium comprising instructions which when executed by a computer cause a processor to perform:
executing a software application on a plurality of different cores;
identifying runtime attributes of the plurality of different cores while executing the software application;
identifying current processing loads of the plurality of different cores;
adding a weight to the runtime attributes of the plurality of different cores to generate weighted runtime attributes;
assigning the software application to a subset of cores from among the plurality of different cores based on the weighted runtime attributes and the current processing loads of the plurality of different cores; and
updating the executing of the software application to execute the software application via the subset of cores.

16. The computer-readable storage medium of claim 15, wherein the adding further comprises adding a first weight to the runtime attributes and a second weight to the current processing loads, wherein the first weight is greater in value than the second weight.

17. The computer-readable storage medium of claim 15, wherein the assigning comprises assigning the software application to a first processing core that has a greater processing load than a second processing core to which the software application is not assigned.

18. The computer-readable storage medium of claim 15, wherein the assigning comprises assigning the software application to a first processing core that has a greater utilization than a second processing core to which the software application is not assigned.

19. The computer-readable storage medium of claim 15, wherein the updating comprises dynamically re-assigning a second software application executing on the subset of cores to a different subset of cores and updating the second software application to execute on the different subset of cores.

20. The computer-readable storage medium of claim 15, wherein the processor is further configured to perform receiving an input defining a predefined weight via a graphical user interface (GUI), and the adding comprises adding the predefined weight to the runtime attributes.
